(19) United States
(12) Patent Application Publication
(10) Pub. No.: US 2018/0134285 A1
(43) Pub. Date: May 17, 2018

(54) AUTONOMOUS DRIVING APPARATUS AND VEHICLE INCLUDING THE SAME

(71) Applicant: LG Electronics Inc., Seoul (KR)

(72) Inventors: Ayoung CHO, Seoul (KR); Salkmann JI, Seoul (KR); Joonhong PARK, Seoul (KR); Yungwoo JUNG, Seoul (KR)

(21) Appl. No.: 15/572,532

(22) PCT Filed: May 6, 2016
(86) PCT No.: PCT/KR2016/004775

§ 371 Date: Nov. 8, 2017

(30) Foreign Application Priority Data
May 8, 2015 (KR) 10-2015-0064313

(51) Int. Cl. B60W 30/09; G05D 1/02; B60R 1/00; B60K 35/00; B60Q 9/00; B60W 50/14; G08G 1/0962; H04N 7/18; G06K 9/00; H04N 5/33; G10L 15/22

(52) U.S. Cl. CPC B60W 30/09; B60W 10/06; B60R 1/00; B60K 35/00; B60Q 9/00; B60W 50/14; G08G 1/09626; H04N 7/181; G06K 9/00805; H04N 5/33; G06K 9/00845; G10L 15/22; B60R 2300/105; B60R 2300/60; B60R 2300/30; B60K 2350/2013; B60R 2300/8093; B60R 2300/8006; B60W 2550/10; G05D 1/0246

(57) ABSTRACT

An autonomous driving apparatus and a vehicle including the same are disclosed. The autonomous driving apparatus including a plurality of cameras, and a processor to verify an object around a vehicle based on a plurality of images acquired from the plurality of cameras, calculate hazard severity of the object based on at least one of a movement speed, direction, distance and size of the object, and output a level of hazard severity information corresponding to the calculated hazard severity when the speed of the vehicle is lower than or equal to a first speed or the vehicle is reversed. Thereby, hazard information may be provided based on verification of objects around the vehicle.

### Technical Field

The present invention relates to an autonomous driving apparatus and a vehicle including the same, and more particularly, to an autonomous driving apparatus capable of providing hazard information based on verification of objects around a vehicle and a vehicle including the same.

### BACKGROUND ART

A vehicle is an apparatus that is moved in a desired direction by a user riding therein. A typical example of the vehicle may be an automobile.

To provide convenience to users who use vehicles, various kinds of sensors and electronic devices have increasingly been applied to vehicles. In particular, various devices for convenience of users related to driving have been developed. A rear camera captures and provides images when a vehicle reverses or is parked.

### DISCLOSURE OF INVENTION

### Technical Problem

Therefore, the present invention has been made in view of the above problems, and it is an object of the present invention to provide an autonomous driving apparatus capable of providing hazard information based on verification of objects around a vehicle and a vehicle including the same.

### Solution to Problem

In accordance with an aspect of the present invention, the above and other objects can be accomplished by the provision of an autonomous driving apparatus including a plurality of cameras, and a processor to verify an object around a vehicle based on a plurality of images acquired from the plurality of cameras, calculate hazard severity of the object based on at least one of a movement speed, direction, distance and size of the object, and output a level of hazard severity information corresponding to the calculated hazard severity when the speed of the vehicle is lower than or equal to a first speed or the vehicle is reversed.

In accordance with another aspect of the present invention, there is provided a vehicle including a steering drive unit to drive a steering apparatus, a brake drive unit to drive a brake apparatus, a power source drive unit to drive a power source, a plurality of cameras, and a processor to verify an object around a vehicle based on a plurality of images acquired from the plurality of cameras, calculate hazard severity of the object based on at least one of a movement speed, direction, distance and size of the object, and output a level of hazard severity information corresponding to the calculated hazard severity when the speed of the vehicle is lower than or equal to a first speed or the vehicle is reversed.

### Advantageous Effects of Invention

According to an embodiment of the present invention, an autonomous driving apparatus and a vehicle including the same include a plurality of cameras and a processor that verifies an object around the vehicle based on a plurality of images acquired from the plurality of cameras, calculates hazard severity of the object based on at least one of the movement speed, direction, distance and size of the object, and outputs a level of hazard severity information corresponding to the calculated hazard severity when the speed of the vehicle is lower than or equal to a first speed or the vehicle is reversed. Thereby, hazard information may be provided based on verification of objects around the vehicle. Accordingly, user convenience may be enhanced.

Particularly, when the vehicle travels autonomously, user convenience may be enhanced by providing hazard information based on verification of objects around the vehicle.

Particularly, by changing the level of the hazard severity information according to recognition of an object, more accurate hazard severity information may be provided.

Meanwhile, as a movement path of an object is displayed by tracking the object, the hazard severity information may be provided in more detail.

If gaze of the driver of the vehicle directed to a place around the display on which an around view image containing hazard severity information is displayed is detected using an internal camera for detection of gaze of the driver when the level of hazard severity of an object around the vehicle rises, warning sound corresponding to first sound is output through an audio output unit. Thereby, the driver may be audibly warned.

When the vehicle travels without the driver present therein, hazard severity information classified into a level is controlled to be transmitted to the mobile terminal of a pre-registered user. Thereby, a dangerous situation may be quickly announced to the user.

When hazard severity information is calculated according to approach of another vehicle during parking, sound corresponding to the hazard severity information is output from the vehicle. Thereby, vehicle collision may be prevented.

### BRIEF DESCRIPTION OF DRAWINGS

The above and other objects, features and other advantages of the present invention will be more clearly understood from the following detailed description taken in conjunction with the accompanying drawings, in which:

FIG. 1 is a conceptual diagram illustrating a vehicle communication system including an autonomous driving apparatus according to an embodiment of the present invention;

FIG. 2A is a view illustrating the exterior of a vehicle provided with various cameras;

FIG. 2B is a view illustrating the exterior of a stereo camera attached to the vehicle of FIG. 2A;

FIG. 2C is a view schematically illustrating the positions of a plurality of cameras attached to the vehicle of FIG. 2A;

FIG. 2D illustrates an exemplary around view image based on images captured by the plurality of cameras of FIG. 2C;

FIGS. 3A and 3B are internal block diagrams illustrating various examples of the autonomous driving apparatus of FIG. 1;

FIGS. 3C and 3D are internal block diagrams illustrating various examples of the autonomous driving apparatus of FIG. 1;

FIG. 3E is an internal block diagram illustrating the display apparatus of FIG. 1;

FIGS. 4A and 4B are internal block diagrams of various examples of the processors of FIGS. 3A to 3D;

FIG. 5 illustrates object detection in the processor of FIGS. 4A and 4B;

FIGS. 6A and 6B illustrate operation of the autonomous driving apparatus of FIG. 1;

FIG. 7 is a block diagram illustrating the interior of a vehicle according to an embodiment of the present invention;

FIG. 8 is a flowchart illustrating operation of an autonomous driving apparatus according to an embodiment of the present invention; and

FIGS. 9A to 14C illustrate the operation of FIG. 8.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

As used herein, the suffixes “module” and “unit” for constituents are added to simply facilitate preparation of this specification, and are not intended to suggest specially important meanings or functions distinguished therebetween. Accordingly, “module” and “unit” may be used interchangeably.

The term “vehicle” employed in this specification may include an automobile and a motorcycle. Hereinafter, description will be given mainly focusing on an automobile.

The vehicle described in this specification may conceptually include a vehicle equipped with an engine as a power source, a hybrid vehicle equipped with both an engine and an electric motor as power sources, and an electric vehicle equipped with an electric motor as a power source.

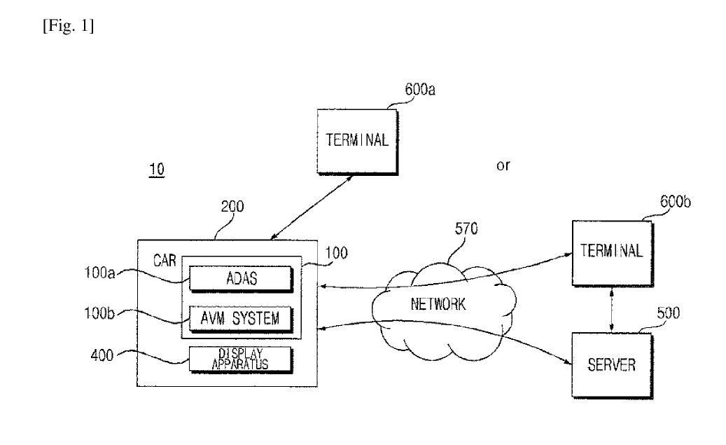

FIG. 1 is a conceptual diagram illustrating a vehicle communication system including an autonomous driving apparatus according to an embodiment of the present invention.

Referring to FIG. 1, the vehicle communication system 10 may include a vehicle 200, terminals 600a and 600b, and a server 500.

The vehicle 200 may be provided therein with an autonomous driving apparatus 100 and a display apparatus 400 for use in vehicles.

The autonomous driving apparatus 100 may include a adaptive driver assistance system 100a and an around view providing apparatus 100b.

For example, autonomous driving of the vehicle may be performed through the adaptive driver assistance system 100a when the speed of the vehicle is higher than or equal to a predetermined speed, and performed through the around view providing apparatus 100b when the speed is lower than the predetermined speed.

As another example, the adaptive driver assistance system 100a and the around view providing apparatus 100b may operate together to perform autonomous driving of the vehicle. In this case, when the speed of the vehicle is higher than or equal to a predetermined speed, a greater weight may be given to the adaptive driver assistance system 100a, and thus autonomous driving may be performed mainly by the adaptive driver assistance system 100a. When the speed of the vehicle is lower than the predetermined speed, a greater weight may be given to the around view providing apparatus 100b, and thus autonomous driving of the vehicle may be performed mainly by the around view providing apparatus 100b.

The adaptive driver assistance system 100a, around view providing apparatus 100b and display apparatus 400 may respectively exchange data with the terminals 600a and 600b or the server 500 using a communication unit (not shown) provided therein or the communication unit provided to the vehicle 200.

For example, when the mobile terminal 600a is positioned inside or near the vehicle, one of the adaptive driver assistance system 100a, the around view providing apparatus 100b and the display apparatus 400 may exchange data with the terminal 600a through short range communication.

As another example, when the terminal 600b is outside and remote from the vehicle, one of the adaptive driver assistance system 100a, the around view providing apparatus 100b and the display apparatus 400 may exchange data with the terminal 600b or the server 500 over a network 570 through telecommunication (e.g., mobile communication).

The terminals 600a and 600b may be mobile terminals such as cellular phones, smartphones, tablets, or wearable devices including smart watches. Alternatively, the terminals may be fixed terminals such as TVs and monitors. Hereinafter, a description will be given on the assumption that the terminal 600 is a mobile terminal such as a smartphone.

The server 500 may be a server provided by the manufacturer of the vehicle or a server operated by a provider providing a vehicle-related service. For example, the server 500 may be a server operated by a provider who provides information about traffic situations.

The adaptive driver assistance system 100a may generate and provide vehicle-related information by performing signal processing of a stereo image received from a stereo camera 195 based on computer vision. Herein, the vehicle-related information may include vehicle control information for direct control of the vehicle or driver assistance information for providing a driving guide to the driver of the vehicle.

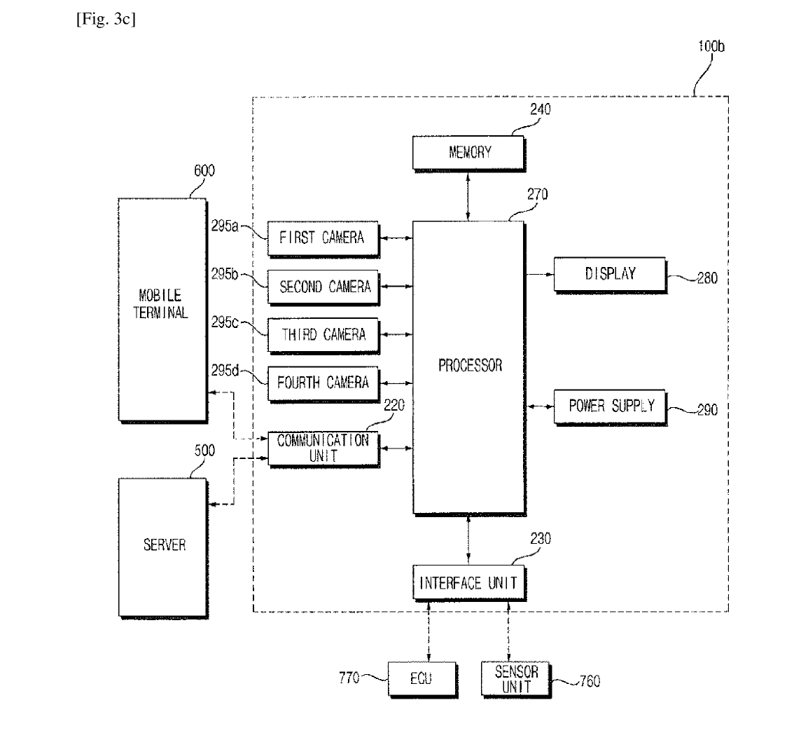

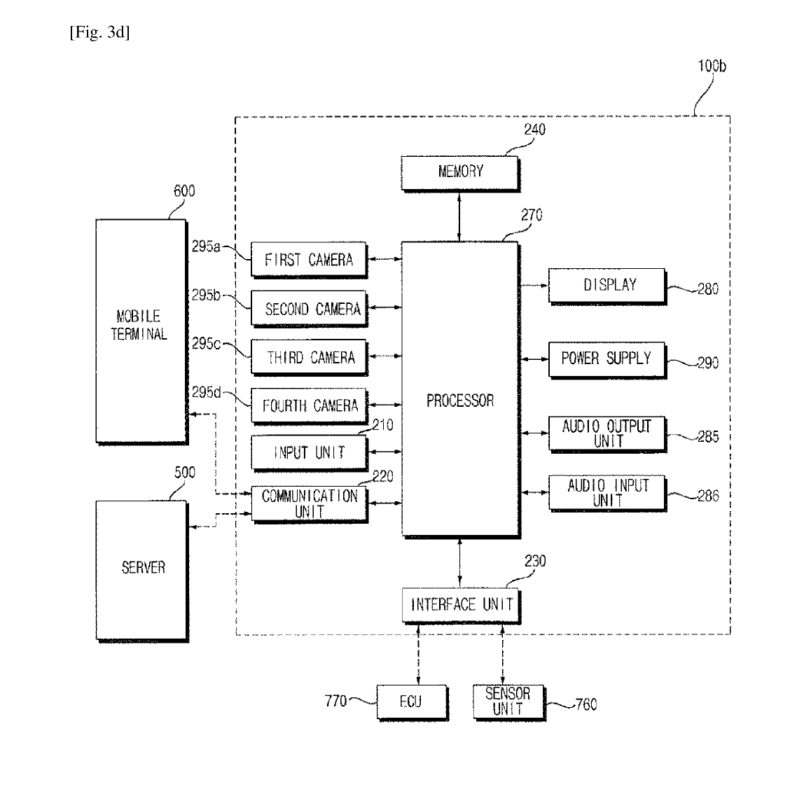

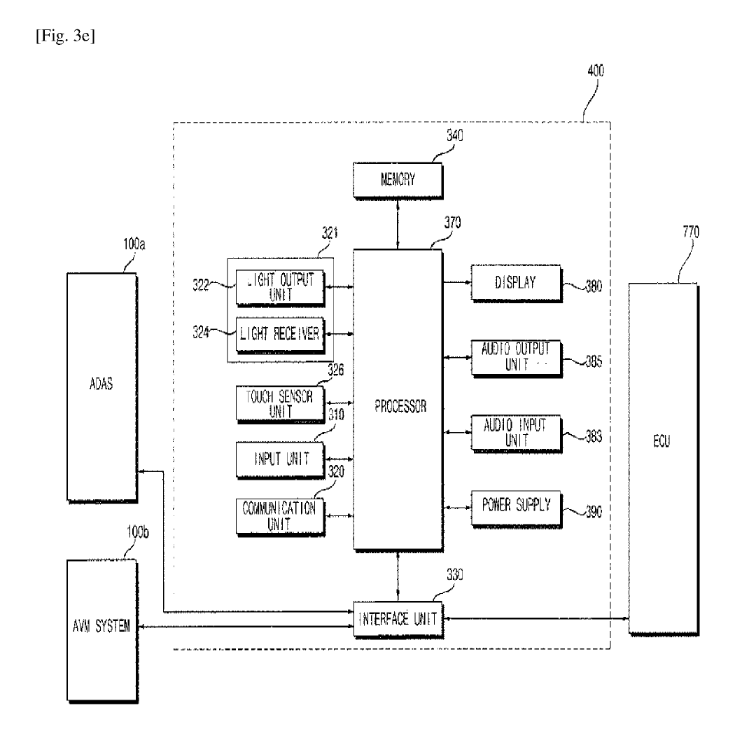

The around view providing apparatus 100b may transmit a plurality of images captured by a plurality of cameras 295a, 295b, 295c and 295d to, for example, a processor 270 (see FIGS. 3C and 3D) in the vehicle 200, and the processor 270 (see FIGS. 3C and 3D) may generate and provide an around view image by synthesizing the images.

The display apparatus 400 may be an audio video navigation (AVN) system.

The display apparatus 400 may include a space recognition sensor unit and a touch sensor unit. Thereby, approach from a long distance may be sensed through the space recognition sensor unit, and touch approach from a short distance may be sensed through the touch sensor unit. In addition, a user interface corresponding to a sensed user gesture or touch may be provided.

According to an embodiment of the present invention, when the speed of the vehicle is lower than or equal to a first speed or the vehicle is reversed, the autonomous driving apparatus 100 may verify an object around the vehicle based on a plurality of images acquired from a plurality of cameras, calculate hazard severity of the object based on at least one of the movement speed, direction, distance and size of the object, and output a level of hazard severity information corresponding to the calculated hazard severity.

According to an embodiment of the present invention, the autonomous driving apparatus 100 may be the around view providing apparatus 100b.

Thereby, when the speed of the vehicle is lower than or equal to the first speed or the vehicle is reversed, the autonomous driving apparatus 100, specifically, the around view providing apparatus 100b, may generate an around view image based on a plurality of images acquired from a plurality of cameras, verify an object in the images acquired from the cameras, calculate hazard severity of the object based on at least one of the movement speed, direction, distance and size of the object, output a level of hazard severity information corresponding to the calculated hazard severity.

According to an embodiment of the present invention, the autonomous driving apparatus 100, specifically, the around view providing apparatus 100b may perform disparity calculation of the around view images based on the images acquired from the plurality of cameras, perform object detection in at least one of the around view images based on the disparity information about the around view images, classify a detected object, and track the detected object.

Thereby, hazard severity may be calculated according to specific verification of the object, and the level of hazard severity information corresponding to the hazard severity may be output.

In addition, by tracking the object, levels of the hazard severity information may be continuously output.

The autonomous driving apparatus 100, specifically, the around view providing apparatus 100b may calculate hazard severity of the object in further consideration of the movement speed and movement direction of the vehicle, and output the level of hazard severity information corresponding to the calculated hazard severity.

For example, the autonomous driving apparatus 100, specifically, the around view providing apparatus 100b may set the level of the hazard severity information in proportion to at least one of the movement speed and size of the object and in inverse proportion to the distance to the object.

The autonomous driving apparatus 100, specifically, the around view providing apparatus 100b may change at least one of the color and size of a hazard severity object indicating the hazard severity information according to the hazard severity.

When the vehicle travels without the driver present therein, the autonomous driving apparatus 100, specifically, the around view providing apparatus 100b may control the level of hazard severity information to be transmitted to the mobile terminal 600a or 600b of a pre-registered user.

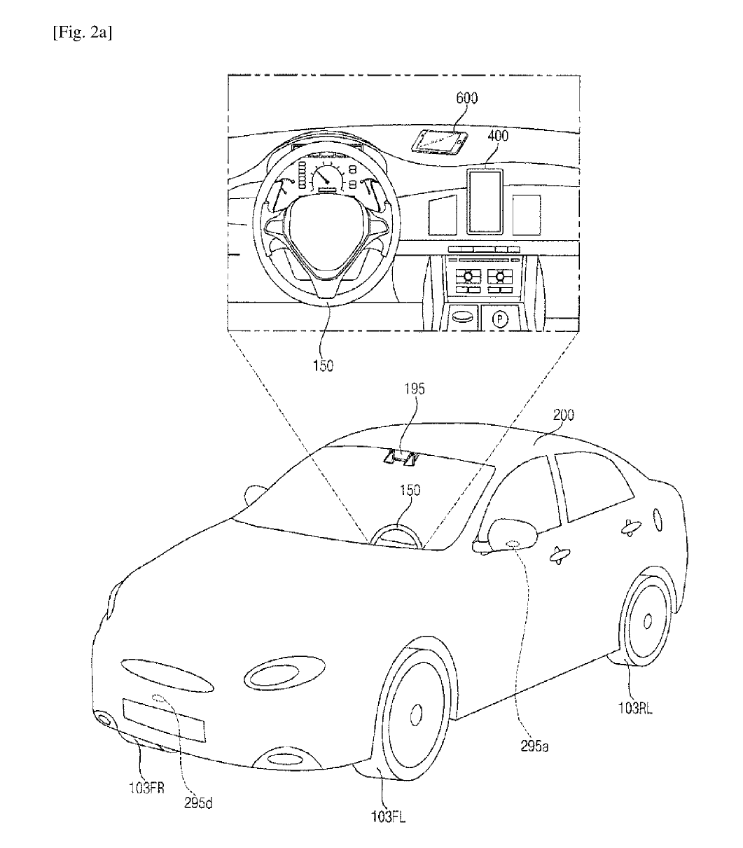

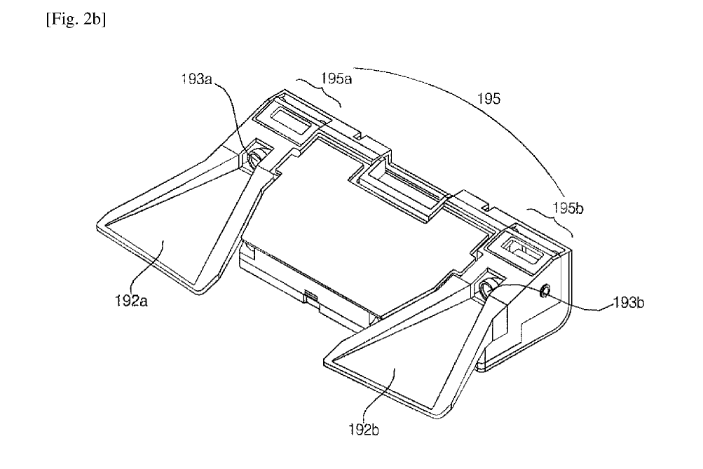

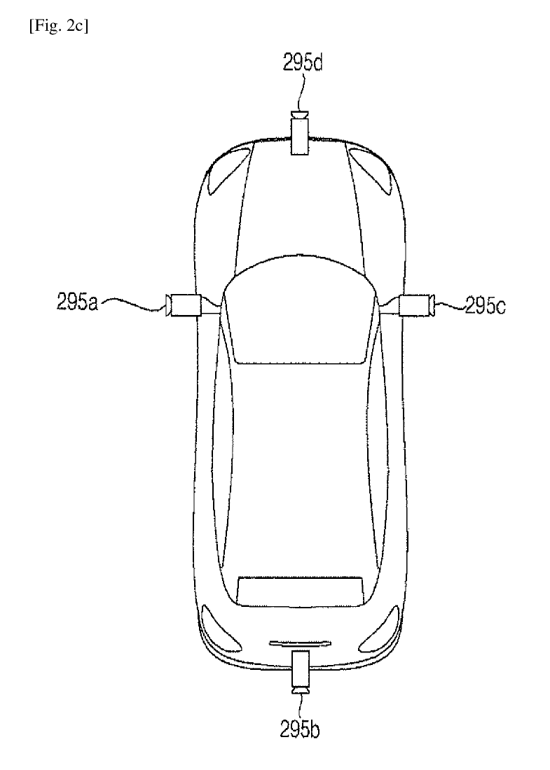

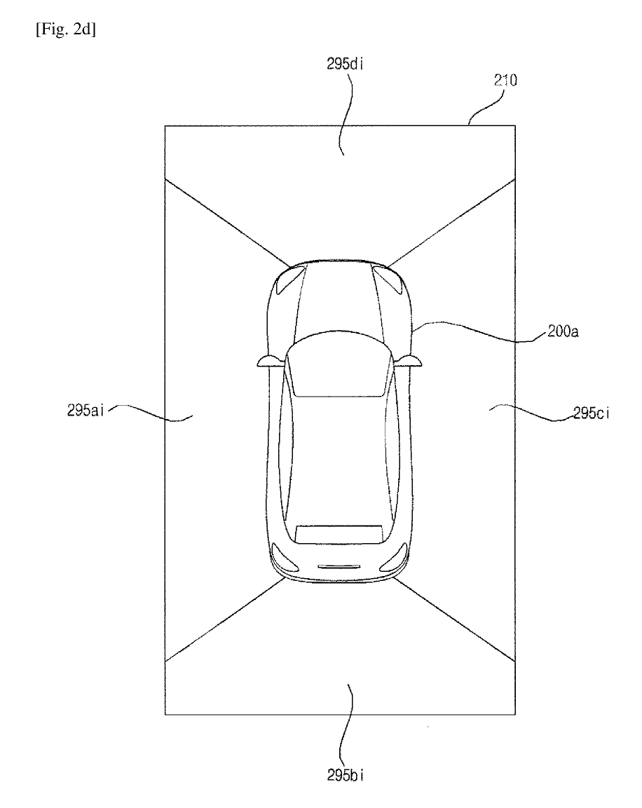

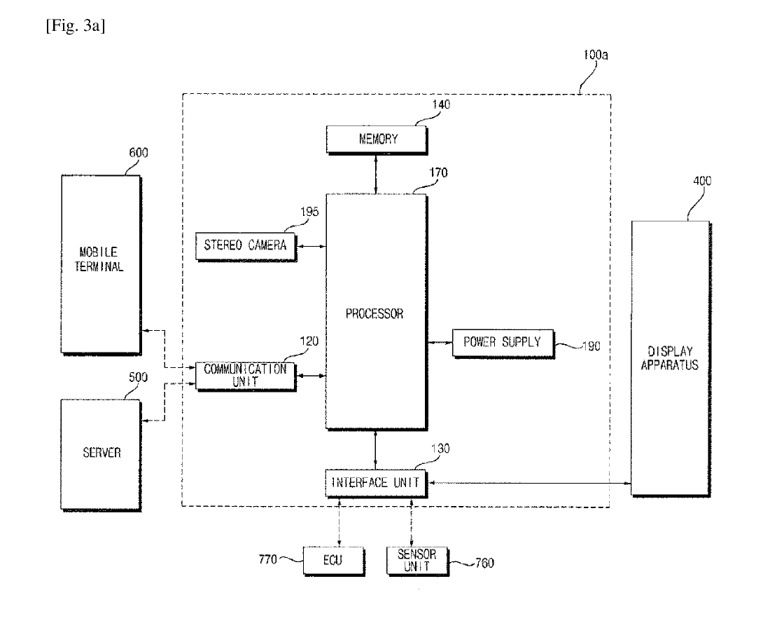

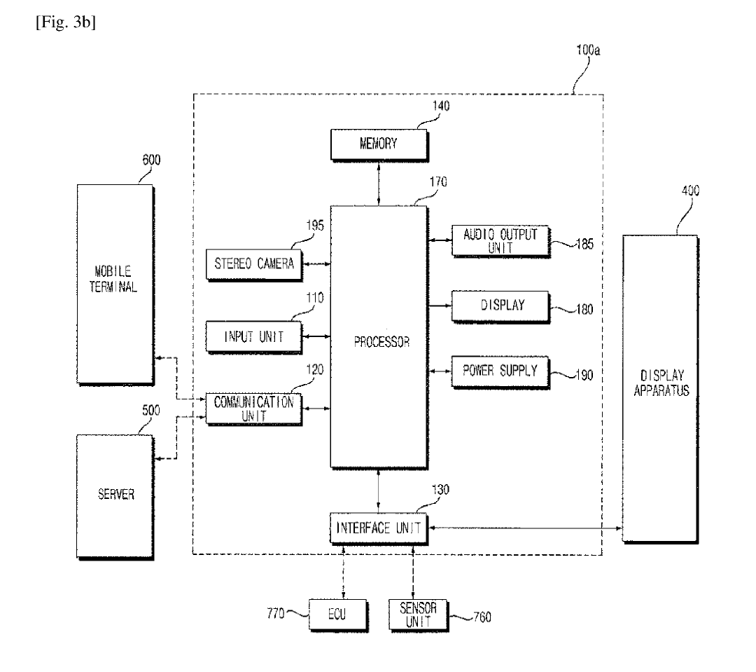

FIG. 2A is a view illustrating the exterior of a vehicle provided with various cameras.

Referring to FIG. 2A, the vehicle 200 may include wheels 103FR, 103FL, 103RL, rotated by a power source, a steering wheel 250 for adjusting the travel direction of the vehicle 200, a stereo camera 195 provided for the adaptive driver assistance system 100a of FIG. 1 in the vehicle 200, and a plurality of cameras 295a, 295b, 295c and 295d mounted to the vehicle in consideration of the autonomous driving apparatus 100b of FIG. 1. For simplicity, only the left camera 295a and the front camera 295d are shown in FIG. 2A.

The stereo camera 195 may include a plurality of cameras, and stereo images acquired by the cameras may be subjected to signal processing in a adaptive driver assistance system 100a (see FIG. 3).

In the drawing, the stereo camera 195 is exemplarily illustrated as having two cameras.

When the speed of the vehicle is lower than or equal to a predetermined speed or the vehicle is reversed, the cameras 295a, 295b, 295c and 295d may be activated to acquire captured images. The images acquired by the cameras may be signal-processed in an around view providing apparatus 100b (see FIG. 3C or 3D).

FIG. 2B is a view illustrating the exterior of a stereo camera attached to the vehicle of FIG. 2A.

Referring to FIG. 2B, the stereo camera module 195 may include a first camera 195a provided with a first lens 193a and a second camera 195b provided with a second lens 193b.

The stereo camera module 195 may include a first light shield 192a and a second light shield 192b, which are intended to block light incident on the first lens 193a and second lens 193b, respectively.

The stereo camera module 195 shown in FIG. 2B may be detachably attached to the ceiling or windshield of the vehicle 200.

A adaptive driver assistance system 100a (see FIG. 3) provided with the stereo camera module 195 may acquire stereo images of the front view of the vehicle from the stereo camera module 195, perform disparity detection based on the stereo images, perform object detection in at least one of the stereo images based on the disparity information, and then continue to track movement of an object after object detection.

FIG. 2C is a view schematically illustrating the positions of a plurality of cameras attached to the vehicle of FIG. 2A, and FIG. 2D illustrates an exemplary around view image based on images captured by the plurality of cameras of FIG. 2C.

Referring to FIG. 2C, the cameras 295a, 295b, 295c and 295d may be disposed on the left side, back, right side and front of the vehicle, respectively.

In particular, the left camera 295a and the right camera 295c may be disposed in a case surrounding the left side view mirror and a case surrounding the right side view mirror, respectively.

The rear camera 295b and the right camera 295d may be disposed near a trunk switch and on or near the emblem.

A plurality of images captured by the cameras 295a, 295b, 295c and 295d is delivered to a processor 270 (see FIG. 3C or 3D) in the vehicle 200, and the processor 270 (see FIG. 3C or 3D) generates an around view image by synthesizing the images.

FIG. 2D illustrates an exemplary around view image 210. The around view image 210 may include a first image region 295ai of an image from the left camera 295a, a second image region 295bi of an image from the rear camera 295b, a third image region 295ci of an image from the right camera 295c, and a fourth image region 295di of an image from the front camera 295d.

FIGS. 3A and 3B are internal block diagrams illustrating various examples of the autonomous driving apparatus of FIG. 1.

FIGS. 3A and 3B show exemplary block diagrams of the adaptive driver assistance system 100a of the autonomous driving apparatus 100.

The adaptive driver assistance system 100a may generate vehicle-related information by signal-processing stereo images received from the stereo camera 195 based on computer vision. Herein, the vehicle-related information may include vehicle control information for direct control of the vehicle or driver assistance information for providing a driving guide to the driver.

Referring to FIG. 3A, the adaptive driver assistance system 100a may include a communication unit 120, an interface unit 130, a memory 140, a processor 170, a power supply 190 and a stereo camera 195.

The communication unit 120 may wirelessly exchange data with a mobile terminal 600 or server 500. In particular, the communication unit 120 may wirelessly exchange data with a mobile terminal of the driver of the vehicle. Applicable wireless data communication schemes may include Bluetooth, Wi-Fi Direct, Wi-Fi and APiX.

The communication unit 120 may receive weather information and traffic situation information (e.g., TPEG (Transport Protocol Experts group) information) from the mobile terminal 600 or server 500. The adaptive driver assistance system 100a may transmit real-time traffic information recognized based on stereo images to the mobile terminal 600 or server 500.

When a user enters the vehicle, the mobile terminal 600 of the user may be paired with the adaptive driver assistance system 100a automatically or by execution of an application by the user.

The interface unit 130 may receive vehicle-related data or transmit a signal processed or generated by the processor 170. To this end, the interface unit 130 may perform data communication with the ECU 770, Audio Video Navigation (AVN) system 400, and sensor unit 760, which are provided in the vehicle, according to a wired or wireless communication scheme.

The interface unit 130 may receive map information related to travel of the vehicle through data communication with the display apparatus 400 for use in vehicles.

The interface unit 130 may receive sensor information from the ECU 770 or sensor unit 760.

Herein, the sensor information may include at least one of vehicle movement direction information, vehicle location information (GPS information), vehicle orientation information, vehicle speed information, vehicle acceleration information, vehicle inclination information, vehicle drive/reverse information, battery information, fuel information, tire information, vehicular lamp information, interior temperature information, and interior humidity information.

Such sensor information may be acquired from a heading sensor, a yaw sensor, a gyro sensor, a position module, a vehicle drive/reverse sensor, a wheel sensor, a vehicle speed sensor, a vehicle body tilt sensor, a battery sensor, a fuel sensor, a tire sensor, a steering sensor based on turning of the steering wheel, an interior temperature sensor, and an interior humidity sensor. The position module may include a GPS module for receiving GPS information.

In the sensor information, the vehicle movement direction information, vehicle location information, vehicle orientation information, vehicle speed information and vehicle inclination information, which are related to travel of the vehicle, may be called vehicle travel information.

The memory 140 may store various kinds of data for overall operation of the adaptive driver assistance system 100a including a program for the processing or control operation of the processor 170.

An audio output unit (not shown) converts an electrical signal from the processor 170 into an audio signal and output the audio signal. To this end, the audio output unit (not shown) may include a speaker. The audio output unit (not shown) may output sound corresponding to operation of the input unit 110, namely a button.

An audio input unit (not shown) may receive a user's voice. To this end, the audio input unit may include a microphone. The received voice may be converted into an electrical signal and delivered to the processor 170.

The processor 170 may control overall operation of each unit in the adaptive driver assistance system 100a.

In particular, the processor 170 performs computer vision-based signal processing.

Thereby, the processor 170 may acquire stereo images of the front view of the vehicle from the stereo camera 195, calculate disparity for the front view of the vehicle based on the stereo images, perform object detection in at least one of the stereo images based on the calculated disparity information, and then continue to track movement of an object after object detection.

In particular, in performing object detection, the processor 170 may perform lane detection, vehicle detection, pedestrian detection, traffic sign recognition, and road surface detection.

In addition, the processor 170 may calculate the distance to a detected vehicle, the speed of the detected vehicle, and a difference in speed from the detected vehicle.

The processor 170 may receive weather information and traffic situation information (e.g., TPEG (Transport Protocol Experts group) information) through the communication unit 120.

The processor 170 may recognize traffic situation information about the surroundings of the vehicle which is recognized by the adaptive driver assistance system 100a based on the stereo images in real time.

The processor 170 may receive, for example, map information from the display apparatus 400 for use in vehicles through the interface unit 130.

The processor 170 may receive sensor information from the ECU 770 or sensor unit 760 through the interface unit 130. Herein, the sensor information may include at least one of vehicle movement direction information, vehicle location information (GPS information), vehicle orientation information, vehicle speed information, vehicle acceleration information, vehicle inclination information, vehicle drive/reverse information, battery information, fuel information, tire information, vehicular lamp information, interior temperature information and interior humidity information.

The power supply 190 may be controlled by the processor 170 to supply electric power necessary for operation of respective constituents. In particular, the power supply 190 may be supplied with power from, for example, a battery in the vehicle.

The stereo camera 195 may include a plurality of cameras. In the following description, the stereo camera 195 is assumed to be provided with two cameras, as described in FIG. 2B.

The stereo camera module 195 may be detachably attached to the ceiling or windshield of the vehicle 200, and include a first camera 195a provided with a first lens 193a and a second camera 195b provided with a second lens 193b.

The stereo camera module 195 may include a first light shield 192a and a second light shield 192b, which are intended to block light incident on the first lens 193a and second lens 193b, respectively.

Referring to FIG. 3B, the adaptive driver assistance system 100a of FIG. 3B may further include an input unit 110, a display 180 and an audio output unit 185, compared to the adaptive driver assistance system 100a of FIG. 3A. Hereinafter, only the input unit 110, display 180 and audio output unit 185 will be described.

The input unit 110 may include a plurality of buttons attached to the driver assistance system 100a, in particular, the stereo camera 195 or a touchscreen. The driver assistance system 100a may be turned on and operated through the plurality of buttons or the touchscreen. Various other input operations may also be performed through the buttons or touchscreen.

The display unit 180 may display an image related to operation of the driver assistance apparatus. To this end, the display unit 180 may include a cluster or head up display (HUD) on the inner front of the vehicle. When the display unit 180 is an HUD, the display unit 180 may include a projection module for projecting an image onto the windshield of the vehicle 200.

The audio output unit 185 may output sound based on an audio signal processed by the processor 170. To this end, the audio output unit 185 may include at least one speaker.

FIG. 3C and 3D are internal block diagrams illustrating various examples of the autonomous driving apparatus of FIG. 1.

FIGS. 3C and 3D show exemplary block diagrams of the around view providing apparatus 100b of the autonomous driving apparatus 100.

The around view providing apparatus 100b of FIGS. 3C and 3D may generate an around view image by synthesizing a plurality of images received from a plurality of cameras 295a, . . . , 295d.

The around view providing apparatus 100b may detect, verify and track an object located around the vehicle based on a plurality of images received from the plurality of cameras 295a, . . . , 295d.

Referring to FIG. 3B, the around view providing apparatus 100b may include a communication unit 220, an interface unit 230, a memory 240, a processor 270, a display 280, a power supply 290 and a plurality of cameras 295a, . . . , 295d.

The communication unit 120 may wirelessly exchange data with the mobile terminal 600 or server 500. In particular, the communication unit 120 may wirelessly exchange data with the mobile terminal of the vehicle driver. Applicable wireless data communication schemes may include Bluetooth, Wi-Fi Direct, Wi-Fi and APiX.

The communication unit 220 may receive, from a mobile terminal 600 or a server 500, schedule information related to scheduled times of the driver of the vehicle or a destination, weather information, and traffic situation information (e.g., TPEG (Transport Protocol Experts group) information). The around view providing apparatus 100b may transmit real-time traffic information recognized based on images to the mobile terminal 600 or server 500.

When a user enters the vehicle, the mobile terminal 600 of the user may be paired with the around view providing apparatus 100b automatically or by execution of an application by the user.

The interface unit 230 may receive vehicle-related data or transmit a signal processed or generated by the processor 270. To this end, the interface unit 230 may perform data communication with the ECU 770 and sensor unit 760, which are provided in the vehicle, using a wired or wireless communication scheme.

The interface unit 230 may receive sensor information from the ECU 770 or sensor unit 760.

Herein, the sensor information may include at least one of vehicle movement direction information, vehicle location information (GPS information), vehicle orientation information, vehicle speed information, vehicle acceleration information, vehicle inclination information, vehicle drive/reverse information, battery information, fuel information, tire information, vehicular lamp information, interior temperature information and interior humidity information.

In the sensor information, the vehicle movement direction information, vehicle location information, vehicle orientation information, vehicle speed information and vehicle inclination information, which are related to traveling of the vehicle, may be referred to as vehicle travel information.

The memory 240 may store various kinds of data for overall operation of the around view providing apparatus 100b including a program for the processing or control operation of the processor 270.

The memory 240 may also store map information related to travel of the vehicle.

The processor 270 may control overall operation of each unit in the around view providing apparatus 100b.

In particular, the processor 270 may acquire a plurality of images from a plurality of cameras 295a, . . . , 295d, and generate an around view image by synthesizing the images.

The processor 270 may perform computer vision-based signal processing. For example, the processor 270 may calculate disparity for the surroundings of the vehicle based on a plurality of images or a generated around view image, perform object detection in the image based on the calculated disparity information, and then continue to track movement of an object after object detection.

In particular, in performing object detection, the processor 270 may perform lane detection, vehicle detection, pedestrian detection, obstacle detection, parking area detection and road surface detection.

In addition, the processor 270 may calculate the distance to a detected vehicle or pedestrian.

The processor 270 may receive sensor information from the ECU 770 or sensor unit 760 through the interface unit 230. Herein, the sensor information may include at least one of vehicle movement direction information, vehicle location information (GPS information), vehicle orientation information, vehicle speed information, vehicle acceleration information, vehicle inclination information, vehicle drive/reverse information, battery information, fuel information, tire information, vehicular lamp information, interior temperature information and interior humidity information.

The display 280 may display an around view image generated by the processor 270. When the around view image is displayed, various user interfaces may also be provided. Touch sensors allowing touch input to the provided user interfaces may also be provided.

The display unit 280 may include a cluster or head up display (HUD) on the inner front of the vehicle. When the display unit 280 is an HUD, the display unit 280 may include a projection module for projecting an image onto the windshield of the vehicle 200.

The power supply 290 may be controlled by the processor 270 to supply electric power necessary for operation of respective constituents. In particular, the power supply 290 may be supplied with power from, for example, a battery in the vehicle.

Preferably, the cameras 295a, . . . , 295d are wide-angle cameras for providing around view images.

Referring now to FIG. 3D, the around view providing apparatus 100b of FIG. 3D, which is similar to the around view providing apparatus 100b of FIG. 3C, further includes an input unit 210, an audio output unit 285, and an audio input unit 286. Hereinafter, only the input unit 210, the audio output unit 285 and the audio input unit 286 will be described.

The input unit 210 may include a plurality of buttons attached to the periphery of the display 280 or a touchscreen disposed on the display 280. The around view providing apparatus 100b may be turned on and operated through the plurality of buttons or the touchscreen. Various other input operations may also be performed through the buttons or touchscreen.

The audio output unit 285 converts an electrical signal from the processor 270 into an audio signal and outputs the audio signal. To this end, the audio output unit 285 may include a speaker. The audio output unit 285 may output sound corresponding to operation of the input unit 210, namely a button.

The audio input unit 286 may receive the user's voice. To this end, the audio input unit may include a microphone. The received voice may be converted into an electrical signal and delivered to the processor 270.

The around view providing apparatus 100b of FIG. 3C or 3D may be an audio video navigation (AVN) system.

FIG. 3E is an internal block diagram illustrating the display apparatus of FIG. 1.

Referring to FIG. 3E, the display apparatus 400 may include an input unit 310, a communication unit 320, a space recognition sensor unit 321, a touch sensor unit 326, an interface unit 330, a memory 340, a processor 370, a display 380, an audio input unit 383, an audio output unit 385, and a power supply 390.

The input unit 310 includes a button attached to the display apparatus 400. For example, the input unit 310 may include a power button. Additionally, the input unit 310 may include at least one of a menu button, a vertical shift button and a horizontal shift button.

A signal input through the input unit 310 may be delivered to the processor 370.

The communication unit 320 may exchange data with a neighboring electronic device. For example, the communication unit 320 may wirelessly exchange data with an electronic device in the vehicle or a server (not shown). In particular, the communication unit 320 may wirelessly exchange data with a mobile terminal of the driver of the vehicle. Applicable wireless data communication schemes may include Bluetooth, Wi-Fi and APiX.

For example, when a user enters the vehicle, the mobile terminal of the user may be paired with the display apparatus 400 automatically or by execution of an application by the user.

The communication unit 320 may include a GPS receiver, and receive GPS information, namely the location information about the vehicle through the GPS receiver.

The space recognition sensor unit 321 may sense approach or movement of a hand of the user. To this end, the space recognition sensor unit 321 may be disposed around the display 380.

The space recognition sensor unit 321 may perform spatial recognition based on light or ultrasound. In the following description, it is assumed that spatial recognition is performed based on light.

The space recognition sensor unit 321 may sense approach or movement of a hand of the user based on light output therefrom and received light corresponding to the output light. In particular, the processor 370 may perform signal processing on electrical signals of the output light and the received light.

To this end, the space recognition sensor unit 321 may include a light output unit 322 and a light receiver 324.

The light output unit 322 may output, for example, infrared (IR) light to sense a hand of the user positioned in front of the display apparatus 400.

When light output from the light output unit 322 is scattered or reflected by the hand of the user positioned in front of the display apparatus 400, the light receiver 324 receives scattered or reflected light. Specifically, the light receiver 324 may include a photodiode, and convert received light into an electrical signal through the photodiode. The converted electrical signal may be input to the processor 370.

The touch sensor unit 326 senses floating touch and direct touch. To this end, the touch sensor unit 326 may include an electrode array and an MCU. When the touch sensor unit operates, an electrical signal is supplied to the electrode array, and thus an electric field is formed on the electrode array.

The touch sensor unit 326 may operate when the intensity of light received by the space recognition sensor unit 321 is higher than or equal to a first level.

That is, when a hand of the user approaches within a predetermined distance, an electrical signal may be supplied to the electrode array in the touch sensor unit 326. An electric field is formed on the electrode array by the electrical signal supplied to the electrode array, and change in capacitance is sensed using the electric field. In addition, floating touch or direct touch is sensed based on the sensed change in capacitance.

In particular, z-axis information as well as x-axis information and y-axis information may be sensed through the touch sensor unit 326 according to approach of the hand of the user.

The interface unit 330 may exchange data with other electronic devices in the vehicle. For example, the interface unit 330 may perform data communication with, for example, the ECU in the vehicle through wired communication.

Specifically, the interface unit 330 may receive vehicle condition information through data communication with, for example, the ECU in the vehicle.

Herein, the vehicle condition information may include at least one of battery information, fuel information, vehicle speed information, tire information, steering information according to rotation of the steering wheel, vehicular lamp information, interior temperature information, exterior temperature information and interior humidity information.

Additionally, the interface unit 330 may receive GPS information from, for example, the ECU in the vehicle. Alternatively, the GPS information received by the display apparatus 400 may be transmitted to the ECU.

The memory 340 may store various kinds of data for overall operation of the display apparatus 400 including a program for the processing or control operation of the processor 370.

For example, the memory 340 may store a map for guiding a travel path of the vehicle.

As another example, the memory 340 may store user information and information about a mobile terminal of a user for pairing with the mobile terminal of the user.

The audio output unit 385 converts an electrical signal from the processor 370 into an audio signal and outputs the audio signal. To this end, the audio output unit 385 may include a speaker. The audio output unit 385 may output sound corresponding to operation of the input unit 310, namely a button.

The audio input unit 386 may receive the user's voice. To this end, the audio input unit may include a microphone. The received voice may be converted into an electrical signal and delivered to the processor 370.

The processor 370 may control overall operation of each unit in the display apparatus 400.

When a hand of the user continuously approaches the display apparatus 400, the processor 370 may continuously calculate x, y and z axis information based on light received by the light receiver 324. In this case, the z axis information may have a gradually decreasing value.

When a hand of the user approaching the display 380 is within a second distance from the display 380 which is shorter than a first distance, the processor 370 may control the touch sensor unit 326 to operate. That is, when the strength of an electrical signal from the space recognition sensor unit 321 is higher than or equal to a reference level, the processor 370 may control the touch sensor unit 326 to operate. Thereby, an electrical signal is supplied to each electrode array in the touch sensor unit 326.

When a hand of the user is positioned within the second distance, the processor 370 may sense floating touch based on a sensing signal sensed by the touch sensor unit 326. In particular, the sensing signal may indicate change in capacitance.

Based on the sensing signal, the processor 370 may calculate x and y axis information about floating touch input, and calculate z axis information corresponding to the distance between the display apparatus 400 and the hand of the user based on change in capacitance.

The processor 370 may change grouping of the electrode arrays in the touch sensor unit 326 according to the distance to the hand of the user.

Specifically, the processor 370 may change grouping of the electrode arrays in the touch sensor unit 326 based on approximate z axis information calculated based on light received by the space recognition sensor unit 321. The size of the electrode array group may be set to increase as the distance increases.

That is, the processor 370 may change the size of a touch sensing cell for the electrode arrays in the touch sensor unit 326 based on the distance information about the hand of the user, namely the z axis information.

The display 380 may separately display an image corresponding to a function set for a button. To display the image, the display 380 may be implemented as various display modules including LCDs and OLEDs. The display 380 may be implemented as a cluster at the inner front of the vehicle.

The power supply 390 may be controlled by the processor 370 to supply electric power necessary for operation of respective constituents.

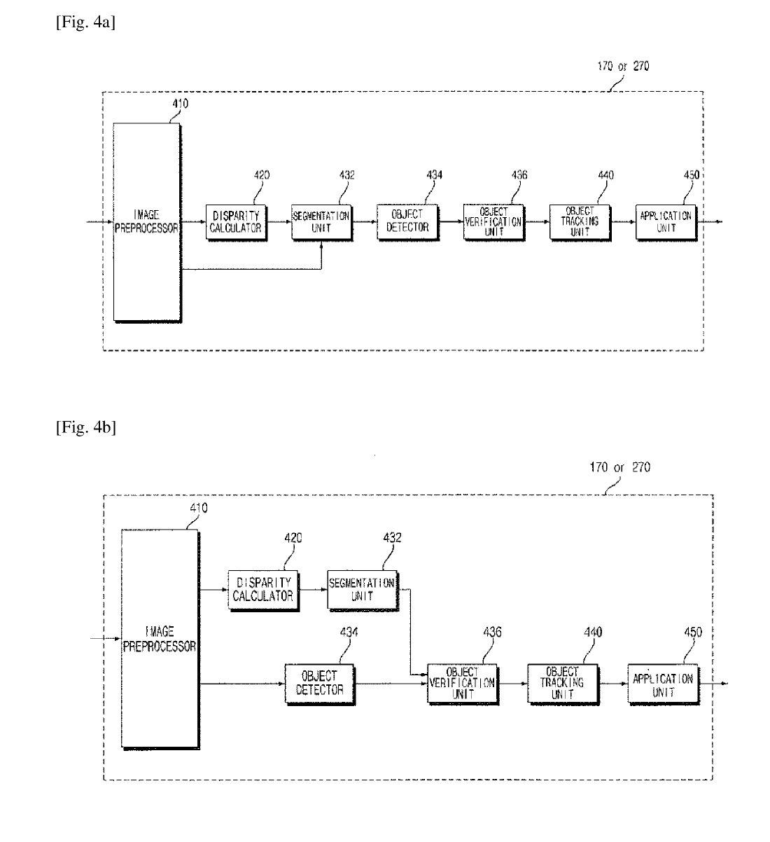

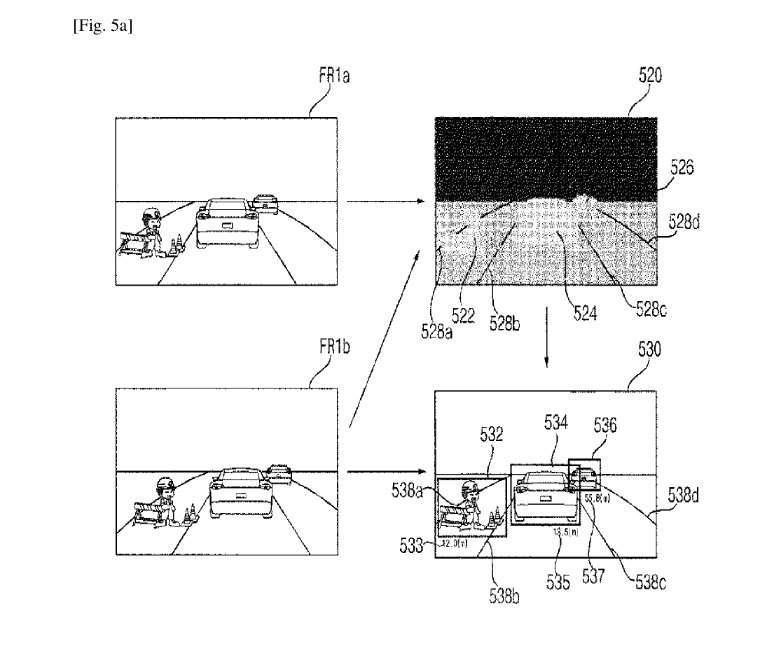

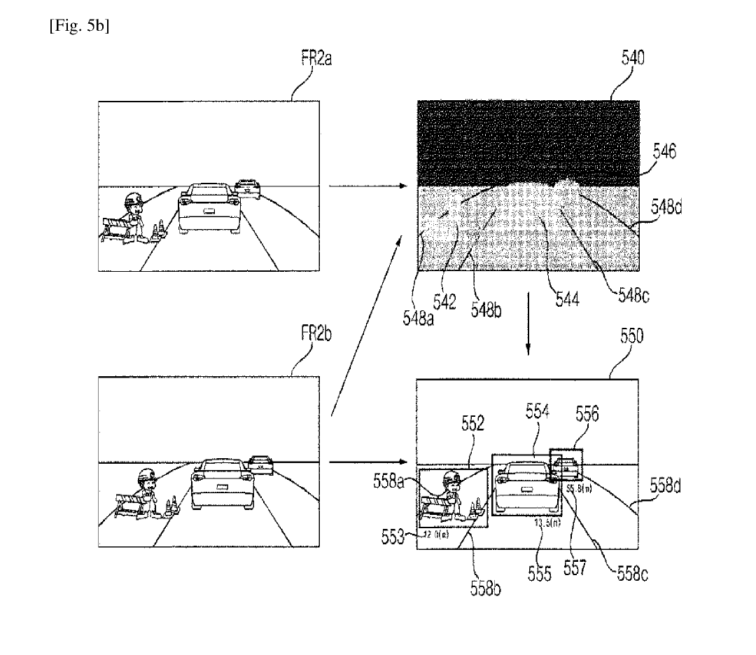

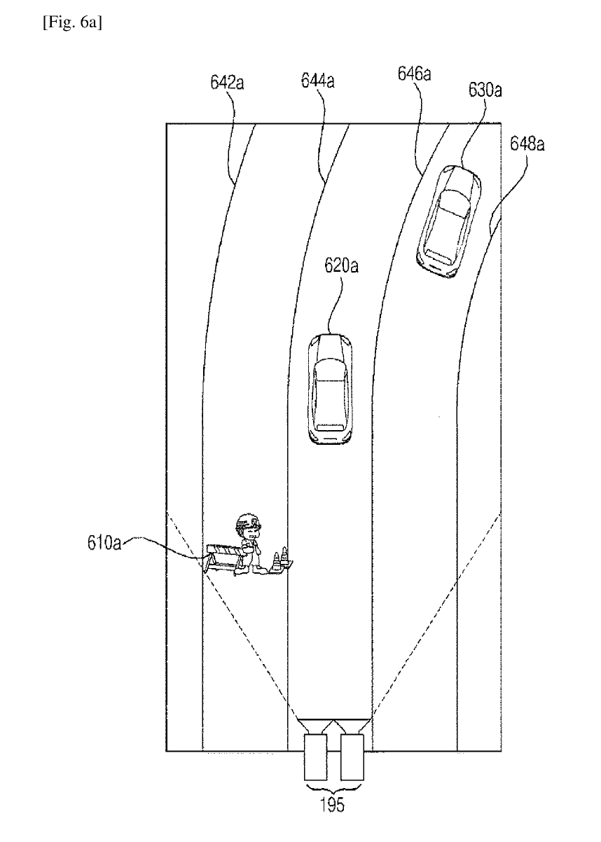

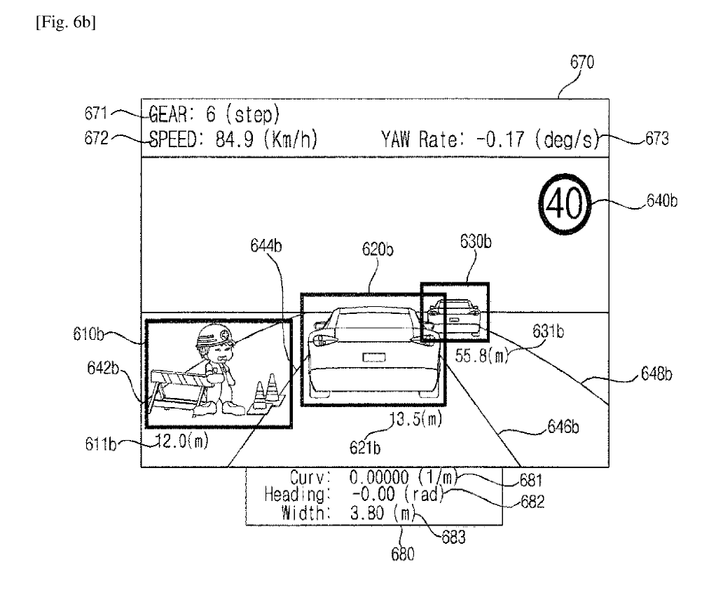

FIG. 4A and 4B are internal block diagrams of various examples of the processors of FIGS. 3A to 3D, and FIG. 5 illustrates object detection in the processors of FIG. 4A and 4B.

FIG. 4A shows an exemplary internal block diagram of the processor 170 of the adaptive driver assistance system 100a of FIGS. 3A and 3B or the processor 270 of the around view providing apparatus 100b of FIGS. 3C and 3D.

The processor 170 or 270 may include an image preprocessor 410, a disparity calculator 420, an object detector 434, an object tracking unit 440, and an application unit 450.

The image preprocessor 410 may receive a plurality of images or a generated around view image from a plurality of cameras 295a, . . . , 295d and perform preprocessing thereof.

Specifically, the image preprocessor 410 may perform noise reduction, rectification, calibration, color enhancement, color space conversion (CSC), interpolation and camera gain control for the images or generated around view image. Thereby, an image clearer than the images captured by the cameras 295a, . . . , 295d or the generated around view image may be acquired.

The disparity calculator 420 receives the plurality of images generated around view image signal-processed by the image preprocessor 410, performs stereo matching upon the images sequentially received for a predetermined time or the generated around view image, and acquires a disparity map according to the stereo matching. That is, the disparity calculator 420 may acquire disparity information on the surroundings of the vehicle.

Herein, stereo matching may be performed in a pixel unit or a predetermined block unit of the images. The disparity map may represent a map indicating numerical values representing binocular parallax information about the images, namely left and right images.

The segmentation unit 432 may perform segmentation and clustering of the images based on the disparity information from the disparity calculator 420.

Specifically, the segmentation unit 432 may separate the background from the foreground in at least one of the images based on the disparity information.

For example, a region of the disparity map which has disparity information less than or equal to a predetermined value may be calculated as the background and excluded. Thereby, the foreground may be separated from the background.

As another example, a region having disparity information greater than or equal to a predetermined value in the disparity map may be calculated as the foreground and the corresponding part may be excluded. Thereby, the foreground may be separated from the background.

By separating the foreground from the background based on the disparity information extracted based on the images, signal processing speed may be increased and signal-processing load may be reduced in the subsequent object detection operation.

The object detector 434 may detect an object based on an image segment from the segmentation unit 432.

That is, the object detector 434 may detect an object in at least one of images based on the disparity information.

Specifically, the object detector 434 may detect an object in at least one of the images. For example, the object detector 434 may detect an object in the foreground separated by the image segment.

Next, the object verification unit 436 may classify and verify the separated object.

To this end, the object verification unit 436 may use an identification technique employing a neural network, a support vector machine (SVM) technique, an identification technique based on AdaBoost using Haar-like features or the histograms of oriented gradients (HOG) technique.

Meanwhile, the object verification unit 436 may verify an object by comparing the detected object with objects stored in the memory 240.

For example, the object verification unit 436 may verify a nearby vehicle, a lane, a road surface, a signboard, a dangerous area, a tunnel, and the like which are positioned around the vehicle.

The object tracking unit 440 may track the verified object. For example, the object tracking unit 440 may sequentially perform verification of an object in the acquired stereo images and computation of the motion or motion vector of the verified object, thereby tracking movement of the object based on the computed motion or motion vector. Thereby, the object tracking unit 440 may track a nearby vehicle, a lane, a road surface, a signboard, a dangerous area, a tunnel, and the like which are positioned around the vehicle.

FIG. 4B shows another exemplary internal block diagram of the processor.

Refer to FIG. 4B, the processor 170 or 270 of FIG. 4B has the same internal units as those of the processor 170 or 270 of FIG. 4A, but differs from the processor 170 or 270 of FIG. 4A in the signal-processing order. Only the difference will be described below.

The object detector 434 may receive a plurality of images or a generated around view image, and detect an object in the plurality of images or the generated around view image. In contrast with the example of FIG. 4A, the object may be directly detected in the images or the generated around view image rather than being detected in segmented images based on the disparity information.

Next, the object verification unit 436 classifies and verifies the detected and separated objects based on an image segment from the segmentation unit 432 and objects detected by the object detector 434.

To this end, the object verification unit 436 may use an identification technique employing a neural network, the support vector machine (SVM) technique, an identification technique based on AdaBoost using Haar-like features, or the histograms of oriented gradients (HOG) technique.

FIG. 5 illustrates operation of the processor 170 or 270 of FIGS. 4A and 4B based on images acquired in first and second frame intervals, respectively.

Referring to FIG. 5, a plurality of cameras 295a, . . . , 295d acquires images FR1a and FR1b sequentially in the first and second frame intervals.

The disparity calculator 420 in the processor 170 or 270 receives the images FR1a and FR1b signal-processed by the image preprocessor 410, and performs stereo matching of the received images FR1a and FR1b, thereby acquiring a disparity map 520

The disparity map 520 provides a level of disparity between the images FR1a and FR1b. The calculated disparity level may be inversely proportional to the distance to the vehicle.

When the disparity map is displayed, high luminance may be provided to a high disparity level and low luminance may be provided to a low disparity level.

In the example of FIG. 5, first to fourth lane lines 528a, 528b, 528c and 528d have corresponding disparity levels and a construction area 522, a first preceding vehicle 524 and a second preceding vehicle 526 have corresponding disparity levels in the disparity map 520.

The segmentation unit 432, the object detector 434, and the object verification unit 436 perform segmentation, object detection and object verification for at least one of the images FR1a and FR1b based on the disparity map 520.

In the illustrated example, object detection and verification are performed for the second image FR1b using the disparity map 520.

That is, object detection and verification may be performed for the first to fourth lane lines 538a, 538b, 538c and 538d, the construction area 532, the first preceding vehicle 534, and the second preceding vehicle 536 in the image 530.

Subsequently, by acquiring images, the object tracking unit 440 may track a verified object.

FIGS. 6A and 6B illustrate operation of the autonomous driving apparatus of FIG. 1.

FIG. 6A illustrates an exemplary front situation of the vehicle whose images are captured by a stereo camera 195 provided in the vehicle. In particular, the vehicle front situation is displayed as a bird's eye view image.

Referring to FIG. 6A, a first lane line 642a, a second lane line 644a, a third lane line 646a, and a fourth lane line 648a are positioned from left to right. A construction area 610a is positioned between the first lane line 642a and the second lane line 644a, a first preceding vehicle 620a is positioned between the second lane line 644a and the third lane line 646a, and a second preceding vehicle 630a is positioned between the third lane line 646a and the fourth lane line 648a.

FIG. 6B illustrates displaying a vehicle front situation recognized by the driver assistance apparatus along with various kinds of information. In particular, the image shown in FIG. 6B may be displayed by the display 180 provided in a driver assistance apparatus or the vehicle display apparatus 400.

FIG. 6B illustrates displaying information based on images captured by the stereo camera 195, in contrast with the example of FIG. 6A.

Referring to FIG. 6B, a first lane line 642b, a second lane line 644b, a third lane line 646b, and a fourth lane line 648b are positioned from left to right. A construction area 610b is positioned between the first lane line 642b and the second lane line 644b, a first preceding vehicle 620b is positioned between the second lane line 644b and the third lane line 646b, and a second preceding vehicle 630b is positioned between the third lane line 646b and the fourth lane line 648b.

The adaptive driver assistance system 100a may perform signal processing based on the stereo images captured by the stereo camera 195, thereby verifying objects corresponding to the construction area 610b, the first preceding vehicle 620b and the second preceding vehicle 630b. In addition, the adaptive driver assistance system 100a may verify the first lane line 642b, the second lane line 644b, the third lane line 646b and the fourth lane line 648b.

In FIG. 6B, to indicate that the objects corresponding to the construction area 610b, the first preceding vehicle 620b and the second preceding vehicle 630b are verified, the objects are highlighted using edge lines.

The adaptive driver assistance system 100a may calculate distance information about the construction area 610b, the first preceding vehicle 620b and the second preceding vehicle 630b based on the stereo images captured by the stereo camera 195.

In FIG. 6B, first calculated distance information 611b, second calculated distance information 621b and third calculated distance information 631b corresponding to the construction area 610b, the first preceding vehicle 620b and the second preceding vehicle 630b, respectively, are displayed.

The adaptive driver assistance system 100a may receive sensor information about the vehicle from the ECU 770 or the sensor unit 760. In particular, the adaptive driver assistance system 100a may receive and display the vehicle speed information, gear information, yaw rate information indicating a variation rate of the yaw of the vehicle and orientation angle information about the vehicle.

In FIG. 6B, vehicle speed information 672, gear information 671 and yaw rate information 673 are displayed at the upper portion 670 of the vehicle front view image, and vehicle orientation angle information 682 is displayed on the lower portion 680 of the vehicle front view image. However, various examples other than the illustrated example are possible. Additionally, vehicle width information 683 and road curvature information 681 may be displayed along with the vehicle orientation angle information 682.

The adaptive driver assistance system 100a may receive speed limit information about the road on which the vehicle is traveling, through the communication unit 120 or the interface unit 130. In FIG. 6B, the speed limit information 640b is displayed.

The adaptive driver assistance system 100a may display various kinds of information shown in FIG. 6B through, for example, the display 180. Alternatively, the adaptive driver assistance system 100a may store the various kinds of information without a separate display operation. In addition, the information may be utilized for various applications.

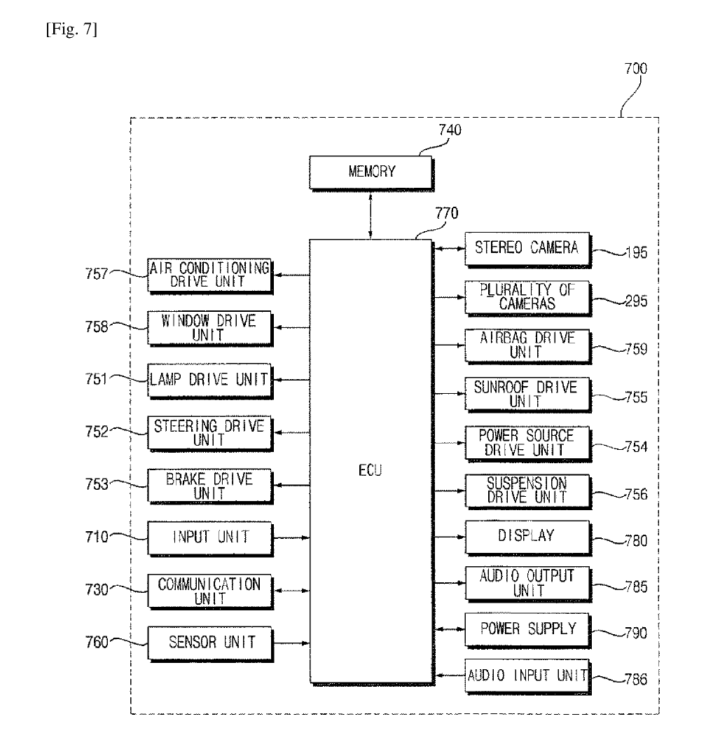

FIG. 7 is a block diagram illustrating the interior of a vehicle according to an embodiment of the present invention.

Referring to FIG. 7, the vehicle 200 may include an electronic control apparatus 700 for control of the vehicle.

The electronic control apparatus 700 may include an input unit 710, a communication unit 720, a memory 740, a lamp drive unit 751, a steering drive unit 752, a brake drive unit 753, a power source drive unit 754, a sunroof drive unit 755, a suspension drive unit 756, an air conditioning drive unit 757, a window drive unit 758, an airbag drive unit 759, a sensor unit 760, an ECU 770, a display 780, an audio output unit 785, an audio input unit 786, a power supply 790, a stereo camera 195, and a plurality of cameras 295.

The ECU 770 may conceptually include the processor 270 illustrated in FIGS. 3C and 3D. Alternatively, a processor for signal processing of images from cameras may be provided separately from the ECU 770.

The input unit 710 may include a plurality of buttons or a touchscreen disposed in the vehicle 200. Various input operations may be performed through the buttons or touchscreen.

The communication unit 720 may wirelessly exchange data with the mobile terminal 600 or server 500. In particular, the communication unit 720 may wirelessly exchange data with a mobile terminal of the driver of the vehicle. Applicable wireless data communication schemes may include Bluetooth, Wi-Fi Direct, Wi-Fi and APiX

The communication unit 720 may receive, from the mobile terminal 600 or server 500, schedule information related to scheduled times for the driver of the vehicle or a destination, weather information, and traffic situation information (e.g., TPEG (Transport Protocol Experts group) information).

When a user enters the vehicle, the mobile terminal 600 of the user may be paired with the electronic control apparatus 700 automatically or by execution of an application by the user.

The memory 740 may store various kinds of data for overall operation of the electronic control apparatus 700 including a program for the processing or control operation of the ECU 770.

The memory 740 may also store map information related to travel of the vehicle.

The lamp drive unit 751 may control lamps disposed inside and outside the vehicle to be turned on/off. The lamp drive unit 751 may also control the intensity and direction of light from the lamps. For example, the lamp drive unit 751 may control a turn signal lamp and a brake lamp.

The steering drive unit 752 may perform electronic control of the steering apparatus (not shown) in the vehicle 200. Thereby, the steering drive unit 752 may change the direction of travel of the vehicle.

The brake drive unit 753 may perform electronic control of a brake apparatus (not shown) in the vehicle 200. For example, by controlling the operation of the brakes disposed on the wheels, the speed of the vehicle 200 may be reduced. In another example, the brake disposed on a left wheel may be operated differently from the brake disposed on a right wheel in order to adjust the travel direction of the vehicle 200 to the left or right.

The power source drive unit 754 may perform electronic control of a power source in the vehicle 200.

For example, if a fossil fuel-based engine (not shown) is the power source, the power source drive unit 754 may perform electronic control of the engine. Thereby, the output torque of the engine may be controlled.

As another example, if an electric motor (not shown) is the power source, the power source drive unit 754 may control the motor. Thereby, the rotational speed and torque of the motor may be controlled.

The sunroof drive unit 755 may perform electronic control of a sunroof apparatus (not shown) in the vehicle 200. For example, the sunroof drive unit 755 may control opening or closing of the sunroof.

The suspension drive unit 756 may perform electronic control of a suspension apparatus (not shown) in the vehicle 200. For example, when a road surface is uneven, the suspension drive unit 756 may control the suspension apparatus to attenuate vibration of the vehicle 200.

The air conditioning drive unit 757 may perform electronic control of an air conditioner (not shown) in the vehicle 200. For example, if the temperature of the interior of the vehicle is high, the air conditioning drive unit 757 may control the air conditioner to supply cool air into the vehicle.

The window drive unit 758 may perform electronic control of a window apparatus in the vehicle 200. For example, the window drive unit 758 may control opening or closing of the left and right windows on both sides of the vehicle.

The airbag drive unit 759 may perform electronic control of an airbag apparatus in the vehicle 200. For example, the airbag drive unit 759 may control the airbag apparatus such that the airbags are inflated when the vehicle is exposed to danger.

The sensor unit 760 senses a signal related to travel of the vehicle 200. To this end, the sensor unit 760 may include a heading sensor, a yaw sensor, a gyro sensor, a position module, a vehicle drive/reverse sensor, a wheel sensor, a vehicle speed sensor, a vehicle body tilt sensor, a battery sensor, a fuel sensor, a tire sensor, a steering sensor based on turning of the steering wheel, a vehicle interior temperature sensor, and a vehicle interior humidity sensor.

Thereby, the sensor unit 760 may acquire sensing signals carrying vehicle movement direction information, vehicle location information (GPS information), vehicle orientation information, vehicle speed information, vehicle acceleration information, vehicle inclination information, vehicle drive/reverse information, battery information, fuel information, tire information, vehicle lamp information, vehicle interior temperature information, and vehicle interior humidity information.

The sensor unit 760 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, and a crankshaft angle sensor (CAS).

The ECU 770 may control overall operations of the respective units in the electronic control apparatus 700.

The ECU 770 may perform a specific operation according to input in the input unit 710, or may receive a signal sensed by the sensor unit 760 and transmit the same to the around view providing apparatus 100b. In addition, the ECU 770 may receive information from the memory 740, and control operation of the respective drive units 751, 752, 753, 754 and 756.

In addition, the ECU 770 may receive weather information and traffic situation information (e.g., TPEG (Transport Protocol Experts group) information) from the communication unit 720.

Meanwhile, the ECU 770 may generate an around view image by synthesizing a plurality of images received from plurality of cameras 295. In particular, when the speed of the vehicle is lower than or equal to a predetermined speed or the vehicle is reversed, the ECU 770 may generate an around view image.

The display 780 may display a vehicle front view image during travel of the vehicle or display an around view image during low-speed travel of the vehicle. In particular, the display 780 may provide various user interfaces in addition to the around view image.

To display the around view image and the like, the display 780 may include a cluster or HUD (Head Up Display) on the inner front of the vehicle. If the display 780 is an HUD, the display 780 may include a projection module for projecting an image onto the windshield of the vehicle 200. The display 780 may include a touchscreen through which input can be provided.

The audio output unit 785 converts an electrical signal from the ECU 770 into an audio signal and outputs the audio signal. To this end, the audio output unit 785 may include a speaker. The audio output unit 785 may output sound corresponding to operation of the input unit 710, namely a button.

The audio input unit 786 may receive the user's voice. To this end, the audio input unit may include a microphone. The received voice may be converted into an electrical signal and delivered to the ECU 770.

The power supply 790 may be controlled by the ECU 770 to supply electric power necessary for operation of respective constituents. In particular, the power supply 790 may be supplied with power from, for example, a battery (not shown) in the vehicle.

The stereo camera 195 is used for operation of the driver assistance apparatus for use in vehicles. For details, refer to the descriptions given above.

A plurality of cameras 295 may be used to provide around view images. To this end, four cameras may be provided as shown in FIG. 2C. For example, the cameras 295a, 295b, 295c and 295d may be disposed on the left side, back, right side and front of the vehicle, respectively. A plurality of images captured by the cameras 295 may be delivered to the ECU 770 or a separate processor (not shown).

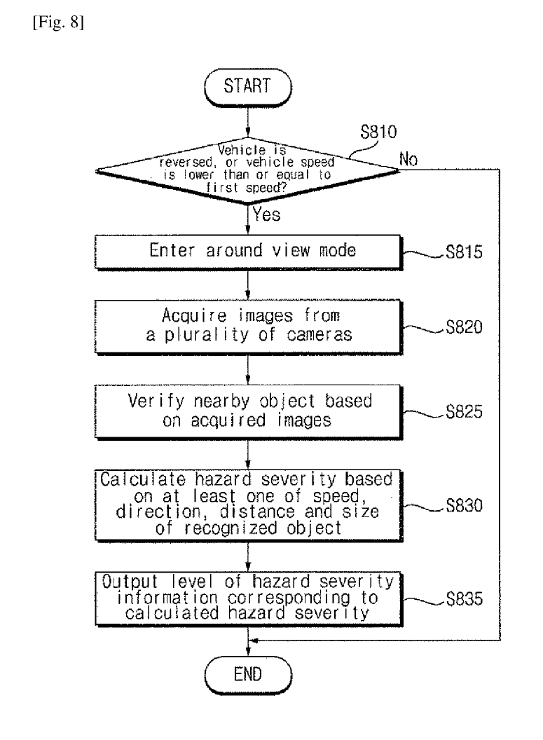

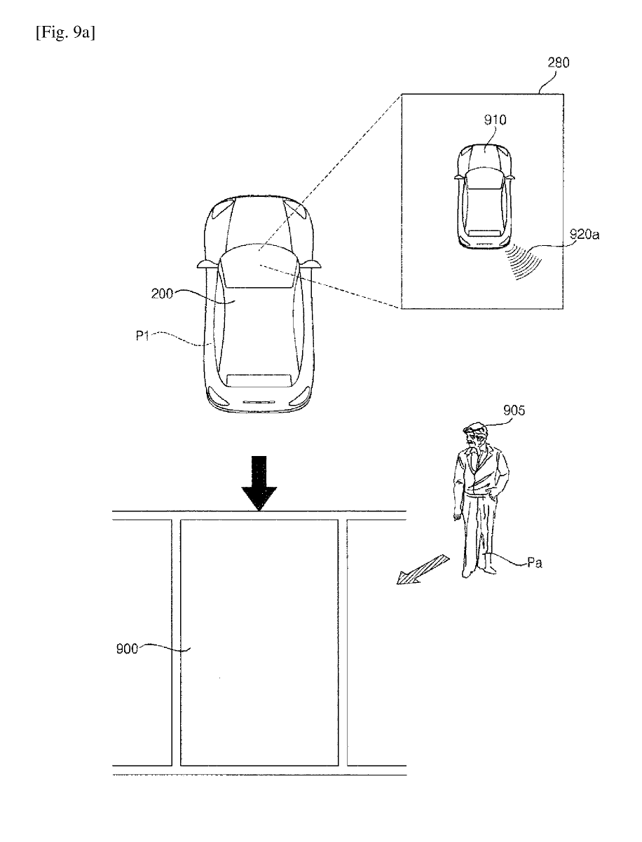

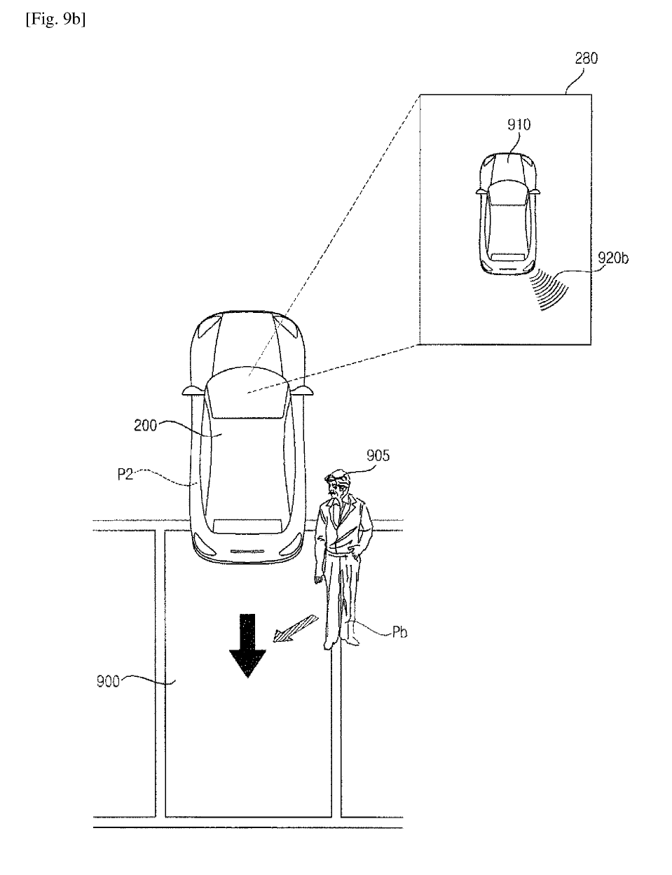

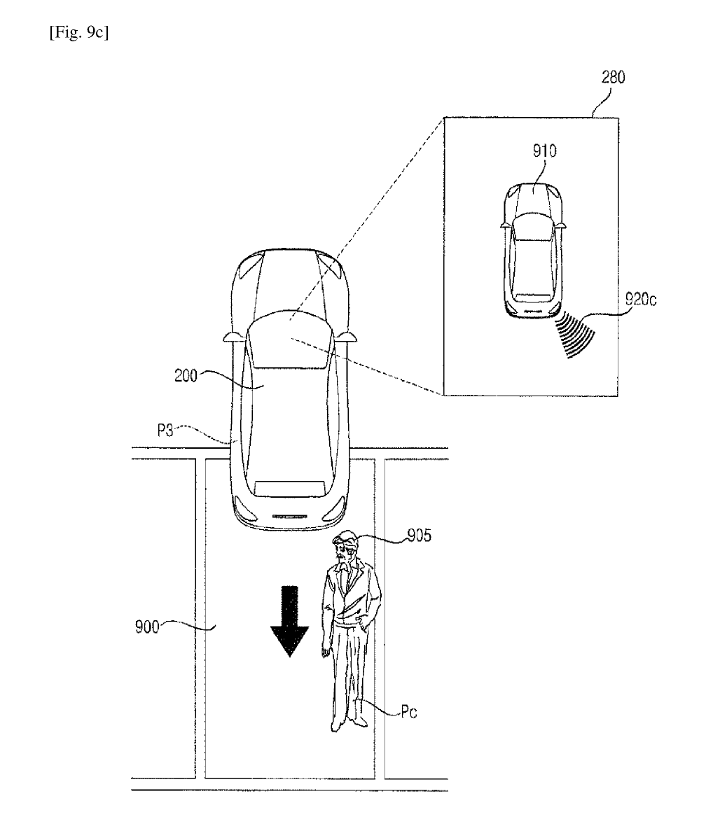

FIG. 8 is flowchart illustrating operation of an autonomous driving apparatus according to an embodiment of the present invention, and FIGS. 9A to 14C illustrate the method of FIG. 8.

Referring to the drawings, the processor 270 of the autonomous driving apparatus 100, specifically, the around view providing apparatus 100b determines whether the vehicle is reversed or the speed of the vehicle is lower than or equal to a first speed (S810). If the vehicle is reversed or the speed of the vehicle is lower than or equal to the first speed, the processor 270 performs a control operation to enter an around view mode (S815).

The processor 270 of the autonomous driving apparatus 100, specifically, the around view providing apparatus 100b may receive vehicle speed information, vehicle movement direction (forward movement, backward movement, left turn or right turn) from the sensor unit 760 of the vehicle through the interface unit 230.

Then, the processor 270 of the autonomous driving apparatus 100, specifically, the around view providing apparatus 100b determines whether the vehicle is reversed or the speed of the vehicle is lower than or equal to the first speed. If the vehicle is reversed or the speed of the vehicle is lower than or equal to the first speed, the processor 270 performs a control operation to enter the around view mode.

That is, the processor 270 of the autonomous driving apparatus 100, specifically, the around view providing apparatus 100b controls a plurality of cameras 295a, 295b, 295c and 295d to be activated according to the around view mode.

Next, the processor 270 of the autonomous driving apparatus 100, specifically, the around view providing apparatus 100b acquires images captured by the activated cameras 295a, 295b, 295c and 295d (S820). Then, the processor 270 verifies objects around the vehicle based on the acquired images (S825). Then, the processor 270 may calculate hazard severity of a recognized object based on at least one of the movement speed, direction, distance and size of the object (S830). Then, the processor 270 may perform a control operation to output a level of hazard severity information corresponding to the calculated hazard severity (S835).

The processor 270 of the autonomous driving apparatus 100, specifically, the around view providing apparatus 100b may generate an around view image as shown in FIG. 2D by synthesizing the images captured by the activated cameras 295a, 295b, 295c and 295d.

Since the activated cameras 295a, 295b, 295c and 295d, which provide a wider angle than the stereo camera 195, are directed to the ground, the processor 270 corrects the captured images in generating the around view image. For example, the processor 270 may perform image processing such that the scaling ratio changes according to the vertical position. Then, the processor 270 may synthesize the images subjected to image processing, particularly, with the image of the vehicle placed at the center thereof.

As described above with reference to FIGS. 4A and 4B, the processor 270 may detect, verify and track an object in the around view image.

In particular, since image regions for the front view, front right-side view and front left-side view of the vehicle overlap each other in the images captured by the side cameras 295a and 295c and the front camera 295d, the processor 270 may calculate the disparity for the surroundings of the vehicle using the overlapping image regions. Then, the processor 270 may perform object detection and verification for the front view, front right-side view and front left-side view of the vehicle.

For example, the processor 270 of the autonomous driving apparatus 100, specifically, the around view providing apparatus 100b may perform vehicle detection, pedestrian detection, lane detection, road surface detection and visual odometry for the front view, front right-side view and front left-side view of the vehicle.

The processor 270 of the autonomous driving apparatus 100, specifically, the around view providing apparatus 100b may perform dead reckoning based on vehicle travel information from the ECU 770 or the sensor unit 760.

The processor 270 of the autonomous driving apparatus 100, specifically, the around view providing apparatus 100b may track egomotion of the vehicle based on dead reckoning. In this case, the egomotion of the vehicle may be tracked based on visual odometry as well as dead reckoning.

After performing object detection for the front view, front right-side view and front left-side view of the vehicle, the processor 270 may calculate hazard severity for a detected object.

For example, the processor 270 may calculate time to collision (TTC) with an object positioned on the front right side of the vehicle based on at least one of the distance to the object, the speed of the object and the difference in speed between the vehicle and the object.

Then, the processor 270 may determine the level of hazard severity information based on the TTC with the object.

For example, as the TTC with the object decreases, the level of safety hazard severity information may be raised. That is, the processor 270 may set the level of hazard severity information in inverse proportion to the TTC with the object.

The processor 270 may calculate hazard severity of an object based on at least one of the movement speed, direction, distance and size of the object, and output a level of hazard severity information corresponding to the calculated hazard severity.

The processor 270 may set the level of hazard severity information in proportion to at least one of the movement speed and size of the object, or set the level of hazard severity information in inverse proportion to the distance to the object.

The processor 270 may calculate hazard severity of the object in further consideration of the movement speed and movement direction of the vehicle, and output a level of hazard severity information corresponding to the calculated hazard severity.

For example, when the vehicle gets close to an object, e.g., a pedestrian according to a high movement speed or movement direction of the vehicle, the processor 270 may set the level of hazard severity information such that the level rises.

In addition, since image regions for the rear view, right rear-side view and rear left-side view of the vehicle overlap each other in the images captured by the side cameras 295a and 295c and the rear camera 295b, the processor 270 may calculate the disparity for the surroundings of the vehicle by synthesizing the images based on the overlapping image regions. Then, the processor 270 may perform object detection and verification for the rear view, right rear-side view and rear left-side view of the vehicle.

After performing object detection for the front view, right rear-side view and rear left-side view of the vehicle, the processor 270 may calculate hazard severity for a detected object.

For example, the processor 270 may calculate time to collision (TTC) with an object positioned on the right rear side of the vehicle based on at least one of the distance to the object, the speed of the object and the difference in speed between the vehicle and the object.

Then, the processor 270 may determine the level of hazard severity information based on the TTC with the object.

The processor 270 may calculate hazard severity of the object positioned on the right rear side of the vehicle based on at least one of the movement speed, direction, distance and size of the object, and output a level of hazard severity information corresponding to the calculated hazard severity.

The processor 270 may set the level of hazard severity information in proportion to at least one of the movement speed and size of the object positioned on the right rear side of the vehicle, or set the level of hazard severity information in inverse proportion to the distance to the object.

The processor 270 may calculate hazard severity of the object positioned on the right rear side of the vehicle in further consideration of the movement speed and movement direction of the vehicle, and output a level of hazard severity information corresponding to the calculated hazard severity.

When the speed of the vehicle is lower than or equal to a first speed or the vehicle is reversed, the processor 270 may control the display 280 to display an around view image containing an image indicating the vehicle and a level of hazard severity information corresponding to an object around the vehicle.

In this case, the processor 270 may perform a control operation such that at least one of the color and size of a hazard severity object indicating hazard severity information is changed according to the calculated hazard severity level.

The processor 270 may perform a further control operation such that the movement path of the object around the vehicle is marked in the around view image.

Alternatively, the processor 270 may perform a control operation such that the movement path of the vehicle is marked in the around view image.

FIG. 9A illustrates a case where the vehicle 200 is backed into a parking area 900.

Referring to FIG. 9A, when the vehicle 200 is reversed from a first position P1, a pedestrian 905 on the right rear side of the vehicle approaches the parking area 900.

When the vehicle 200 is reversed, the autonomous driving apparatus 100, specifically, the around view providing apparatus 100b activates a plurality of cameras 295a, 295b, 295c and 295d, and the processor 270 generates an around view image based on the images from the cameras 295a, 295b, 295c and 295d.

The processor 270 may calculate a disparity for an object around the vehicle based on images acquired from the cameras 295a, 295b, 295c and 295d.

In this case, the disparity may be calculated based on the around view image.

However, embodiments of the present invention are not limited thereto. The disparity may be calculated for an object which commonly appears in the images acquired from the cameras 295a, 295b, 295c and 295d.

According to an embodiment of the present invention, disparity calculation may be performed based on not only the around view image but also images of a wider view acquired from the cameras 295a, 295b, 295c and 295d. Thereby, hazard severity may be calculated for an object which is not shown in the around view image in addition to an object in the around view image.

That is, the processor 270 may calculate hazard severity for the object 905 positioned on the right rear side of the vehicle, and perform a control operation such that a hazard severity object 920a indicating the calculated hazard severity is displayed on the display 180 along with a vehicle image 910, as shown in FIG. 9A.

In particular, the processor 270 may perform a control operation such that an around view image containing the vehicle image 910 and the hazard severity object 920a indicating the calculated hazard severity is displayed on the display 180.

The color of the hazard severity object 920a shown in FIG. 9A may be green.

FIG. 9B illustrates another case where the vehicle 200 is backed into the parking area 900.

Referring to FIG. 9B, the vehicle 200 of FIG. 9B is located at a second position P2 closer to the parking area 900 than the position of the vehicle 200 of FIG. 9A, and the pedestrian 905 on the right rear side of the vehicle is closer to the vehicle 200 than in the case of FIG. 9A.

The processor 270 may calculate hazard severity for the object 905 positioned on the right rear side of the vehicle, and perform a control operation such that a hazard severity object 920b indicating the calculated hazard severity is displayed on the display 180 along with the vehicle image 910, as shown in FIG. 9B.

In particular, the processor 270 may perform a control operation such that an around view image containing the vehicle image 910 and the hazard severity object 920b indicating the calculated hazard severity is displayed on the display 180.

Since the distance between the vehicle 200 and the pedestrian 905 in FIG. 9B is shorter than in the case of FIG. 9A, the processor 270 may set the hazard severity information of FIG. 9B to a higher level than the hazard severity information of FIG. 9A.

The color of the hazard severity object 920b shown in FIG. 9B may be yellow, which is more visible than the color adopted in FIG. 9A. As the color changes according to the hazard severity, the driver may intuitively recognize the hazard severity.

FIG. 9C illustrates another case where the vehicle 200 is backed into the parking area 900.

Referring to FIG. 9C, the vehicle 200 of FIG. 9C is located at a third position P3 closer to the parking area 900 than the position of the vehicle 200 of FIG. 9B, and the pedestrian 905 on the right rear side of the vehicle is closer to the vehicle 200 than in the case of FIG. 9B.

The processor 270 may calculate hazard severity for the object 905 positioned on the right rear side of the vehicle, and perform a control operation such that a hazard severity object 920c indicating the calculated hazard severity is displayed on the display 180 along with the vehicle image 910, as shown in FIG. 9C.

In particular, the processor 270 may perform a control operation such that an around view image containing the vehicle image 910 and the hazard severity object 920c indicating the calculated hazard severity is displayed on the display 180.

Since the distance between the vehicle 200 and the pedestrian 905 in FIG. 9C is shorter than in the case of FIG. 9C, the processor 270 may set the hazard severity information of FIG. 9C to a higher level than the hazard severity information of FIG. 9B.

The color of the hazard severity object 920c shown in FIG. 9C may be red, which is more visible than the color adopted in FIG. 9B. As the color changes according to the hazard severity, the driver may intuitively recognize the hazard severity.

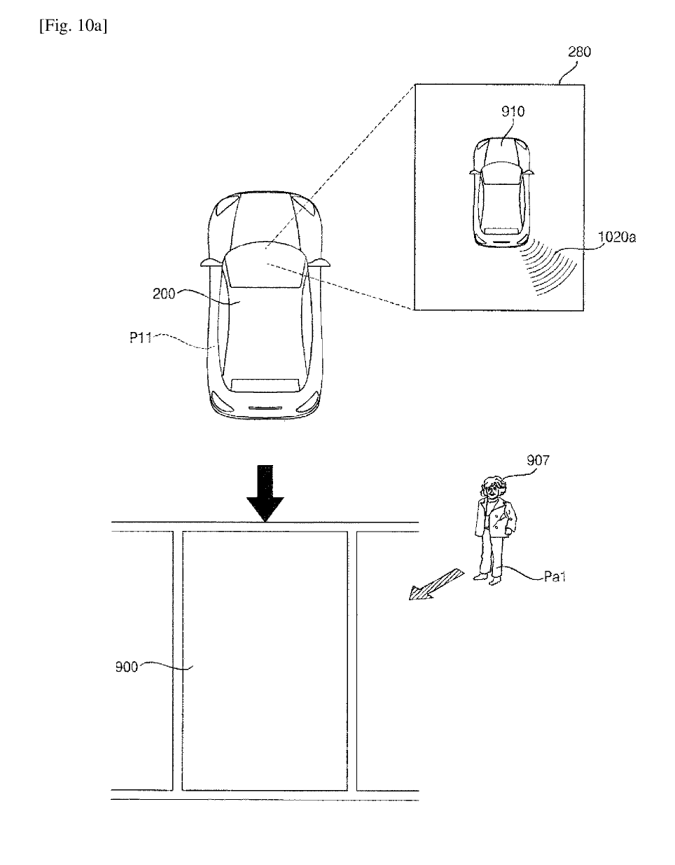

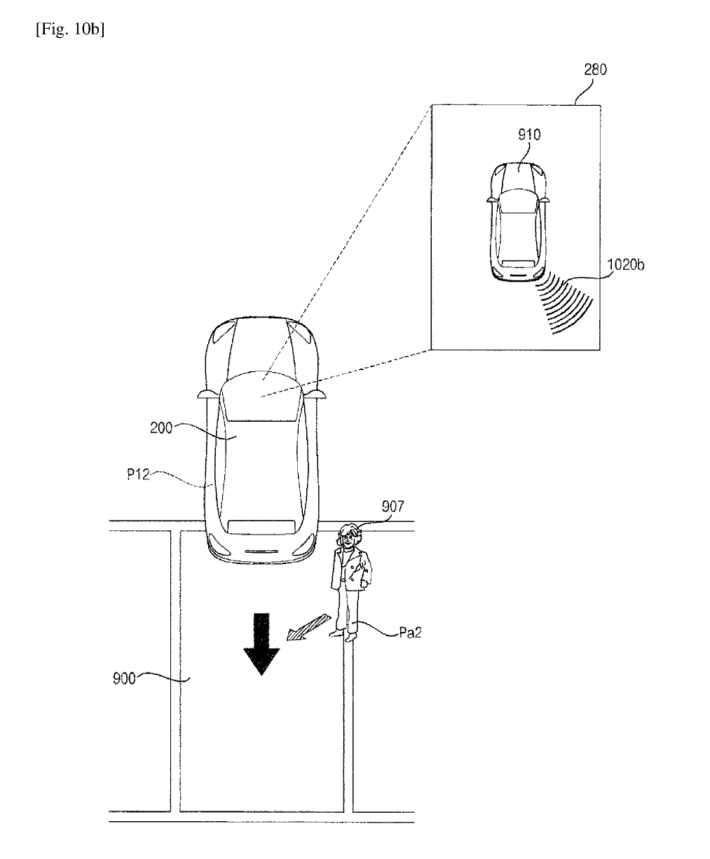

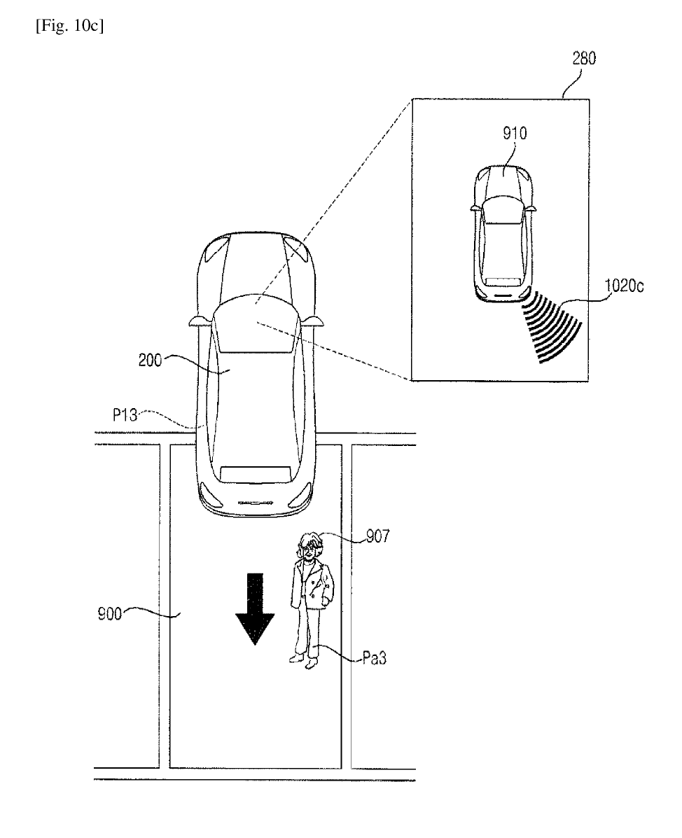

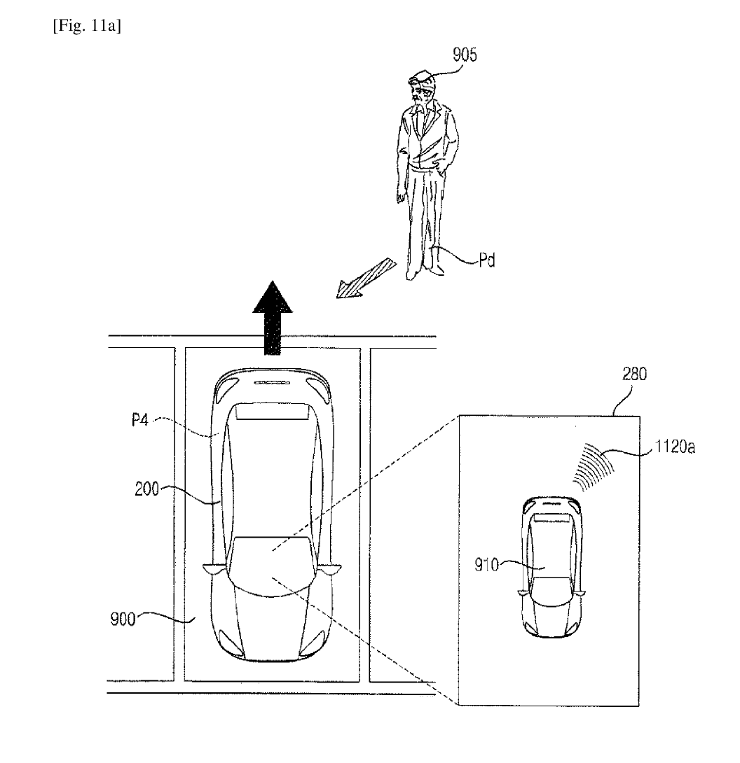

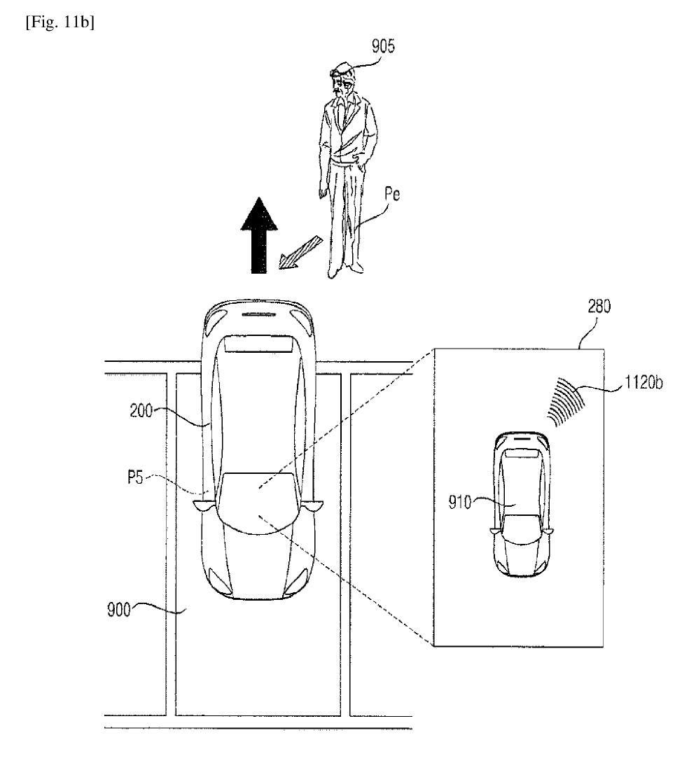

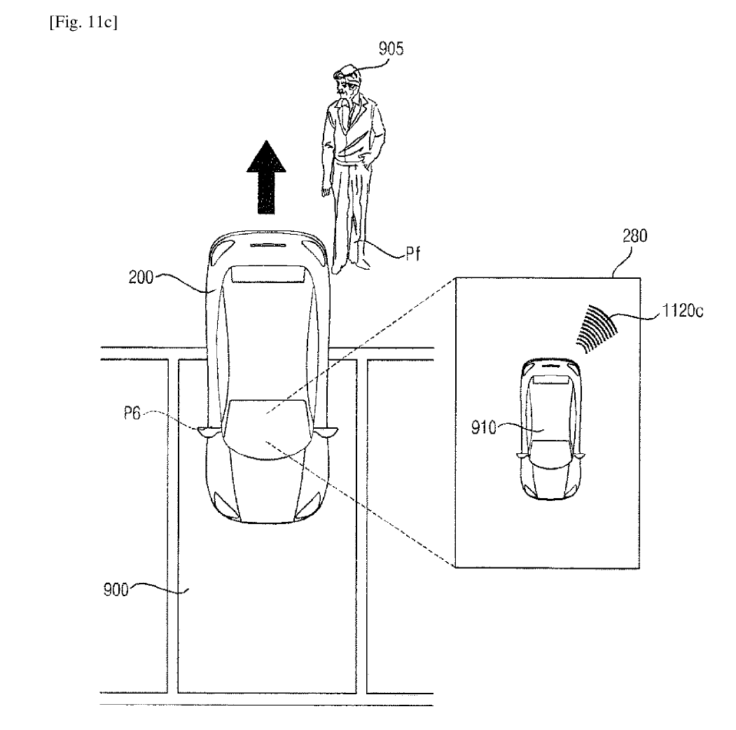

Next, FIGS. 10A to 10C correspond to FIGS. 9A to 9C.

In this example, a pedestrian 907 is a child, while the pedestrian 905 of FIGS. 9A to 9C is an adult.

The processor 270 may perform a control operation such that the hazard severity level changes according to the size of a verified object. For example, the hazard severity level may be set to rise as the size of the object increases.

If the verified pedestrian is a child rather than an adult, the processor 270 may set the hazard severity to a higher level than when the pedestrian is an adult. When the pedestrian is a child, the hazard severity level is preferably raised since the child is likelier to approach the vehicle 200 without recognizing the vehicle 200 than the adult.

When the pedestrian is a child, the processor 270 preferably sets the size of the hazard severity object to be larger than the size thereof given for the adult.

FIG. 10A illustrates a case where the vehicle 200 is located at a first position P11 and the pedestrian 907 is located on the right rear side of the vehicle.

The processor 270 may calculate hazard severity for the object 907 positioned on the right rear side of the vehicle, and perform a control operation such that a hazard severity object 1020a indicating the calculated hazard severity is displayed on the display 180 along with a vehicle image 910, as shown in FIG. 10A.

The color of the hazard severity object 1020a shown in FIG. 10A may be green.

Preferably, the hazard severity object 1020a shown in FIG. 10A is larger than the hazard severity object 920a shown in FIG. 9A, as described above.

FIG. 10B illustrates another case where the vehicle 200 is backed into the parking area 900.

Referring to FIG. 10B, the vehicle 200 of FIG. 10B is located at a second position P12 closer to the parking area 900 than the position of the vehicle 200 of FIG. 10A, and the pedestrian 907 on the right rear side of the vehicle is closer to the vehicle 200 than in the case of FIG. 10A.

The processor 270 may calculate hazard severity for the object 907 positioned on the right rear side of the vehicle, and perform a control operation such that a hazard severity object 1020b indicating the calculated hazard severity is displayed on the display 180 along with the vehicle image 910, as shown in FIG. 10B.

Since the distance between the vehicle 200 and the pedestrian 907 in FIG. 10B is shorter than in the case of FIG. 10A, the processor 270 may set the hazard severity information of FIG. 10B to a higher level than the hazard severity information of FIG. 10A.

The color of the hazard severity object 1020b shown in FIG. 10B may be yellow, which is more visible than the color adopted in FIG. 10A. As the color changes according to the hazard severity, the driver may intuitively recognize the hazard severity.

Preferably, the hazard severity object 1020b shown in FIG. 10B is larger than the hazard severity object 920b shown in FIG. 9B, as described above.

FIG. 10C illustrates another case where the vehicle 200 is backed into the parking area 900.

Referring to FIG. 10C, the vehicle 200 of FIG. 10C is located at a third position P13 closer to the parking area 900 than the position of the vehicle 200 of FIG. 10B, and the pedestrian 907 on the right rear side of the vehicle is closer to the vehicle 200 than in the case of FIG. 10B.

The processor 270 may calculate hazard severity for the object 907 positioned on the right rear side of the vehicle, and perform a control operation such that a hazard severity object 1020c indicating the calculated hazard severity is displayed on the display 180 along with the vehicle image 910, as shown in FIG. 10C.

Since the distance between the vehicle 200 and the pedestrian 907 in FIG. 10C is shorter than in the case of FIG. 10B, the processor 270 may set the hazard severity information of FIG. 10C to a higher level than the hazard severity information of FIG. 10B.

The color of the hazard severity object 1020c shown in FIG. 10C may be red, which is more visible than the color adopted in FIG. 10B. As the color changes according to the hazard severity, the driver may intuitively recognize the hazard severity.

Preferably, the hazard severity object 1020c shown in FIG. 10C is larger than the hazard severity object 920c shown in FIG. 9C, as described above.

FIGS. 11A to 11C illustrate a case where a hazard severity level is changed according to the distance to a nearby pedestrian 905 when the vehicle 200 is backed out of the parking area 900.

The movement illustrated in FIGS. 11A to 11C is reverse to the movement illustrated in FIG. 9A to 9C. The color of a hazard severity object 1120a shown in FIG. 11A may be green. A hazard severity object 1120b shown in FIG. 11B may be displayed in yellow to indicate that the level of the hazard severity is higher than that of the hazard severity of FIG. 11A. A hazard severity object 1120c shown in FIG. 11C may be displayed in red to indicate that the level of the hazard severity is higher than that of the hazard severity of FIG. 11B. As the color changes according to the hazard severity, the driver may intuitively recognize the hazard severity.

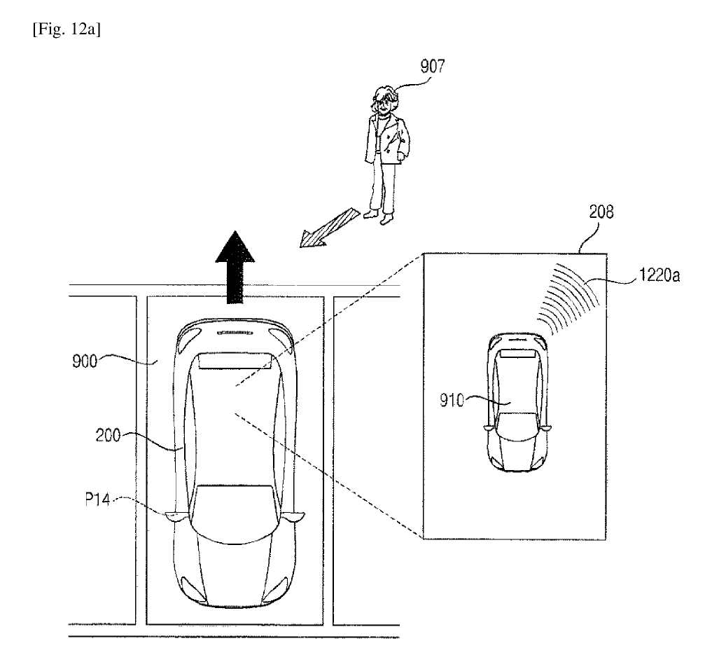

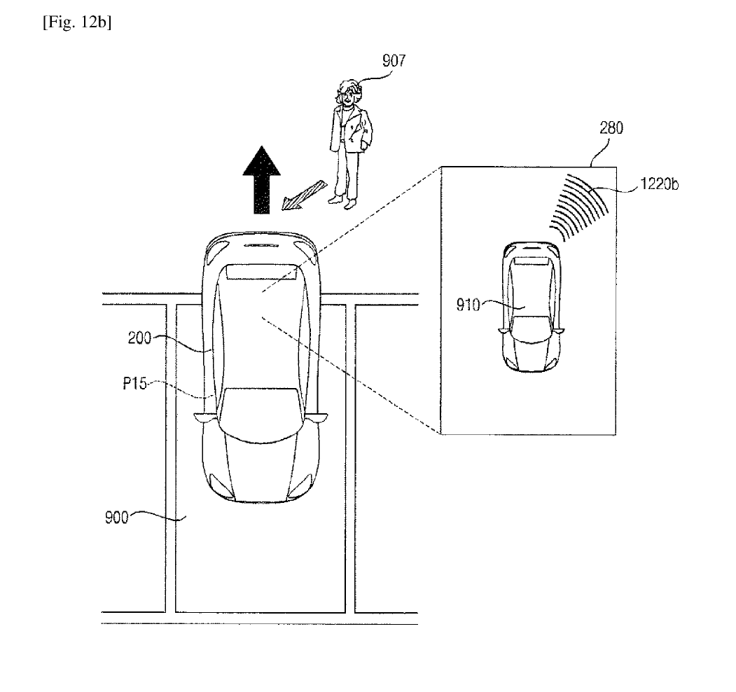

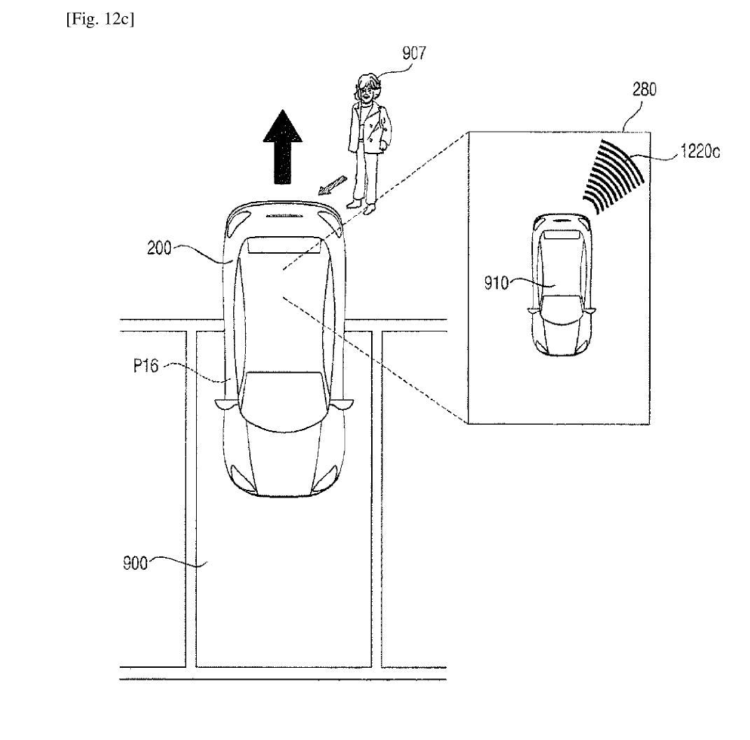

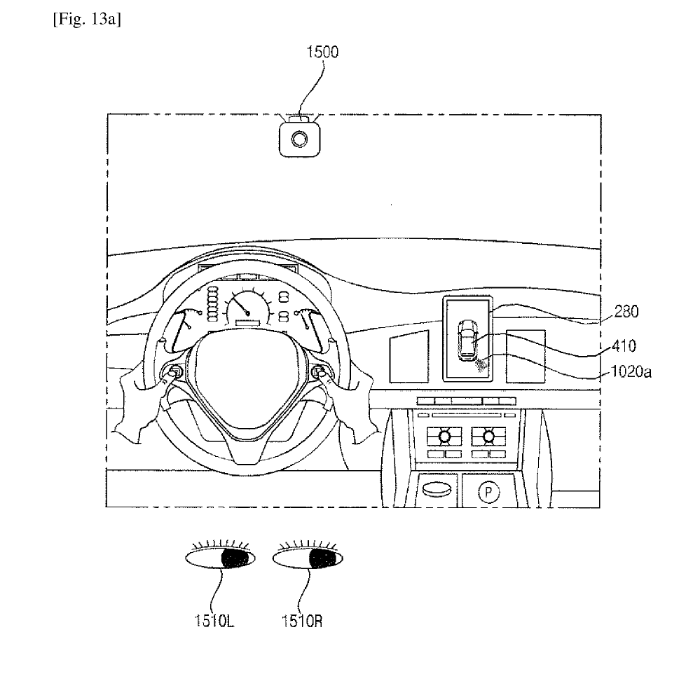

FIGS. 12A to 12C illustrate a case where a hazard severity level is changed according to the distance to a nearby pedestrian 907 when the vehicle 200 is backed out of the parking area 900.

The movement illustrated in FIGS. 12A to 12C is reverse to the movement illustrated in FIGS. 10A to 10C. The color of a hazard severity object 1220a shown in FIG. 12A may be green. A hazard severity object 1220b shown in FIG. 12B may be displayed in yellow to indicate that the level of the hazard severity is higher than that of the hazard severity of FIG. 12A. A hazard severity object 1220c shown in FIG. 12C may be displayed in red to indicate that the level of the hazard severity is higher than that of the hazard severity of FIG. 12B. As the color changes according to the hazard severity, the driver may intuitively recognize the hazard severity.

Preferably, the hazard severity object 1220a, 1220b and 1220c of FIGS. 12A to 12C are larger than the hazard severity objects 1120a, 1120b and 1120c of FIGS. 11A to 11C.

The processor 270 may perform the calculation operation such that the level of hazard severity rises in proportion to the movement speed of the object.

In contrast with the cases of FIGS. 9A to 12C, when an object is positioned in a region within a generated around view image, the processor 270 may perform a control operation such that the recognized and verified object is also displayed as a graphic image. In this case, a hazard severity object indicating the level of hazard severity described above may also be displayed. Thereby, the driver of the vehicle may recognize the neighboring object and the hazard the severity level through the around view image.

The processor 270 may perform a further control operation such that the movement path of an object around the vehicle is marked in the around view image. The driver of the vehicle may predict the direction of movement of the object around the vehicle based on the movement path.

The processor 270 may perform a further control operation such that the movement path of the vehicle is marked in the around view image. Thereby, the distance to an object around the vehicle with respect to the predicted movement path of the vehicle may be predicted based on the movement path.

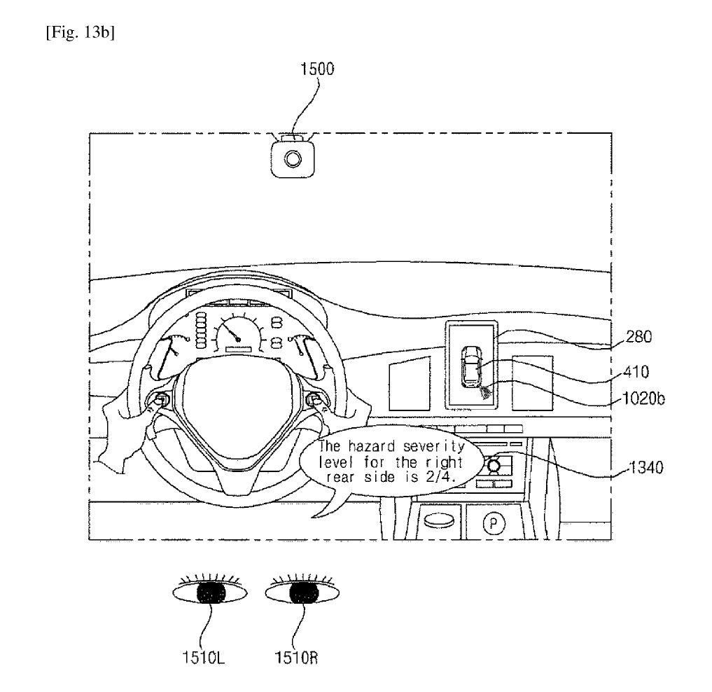

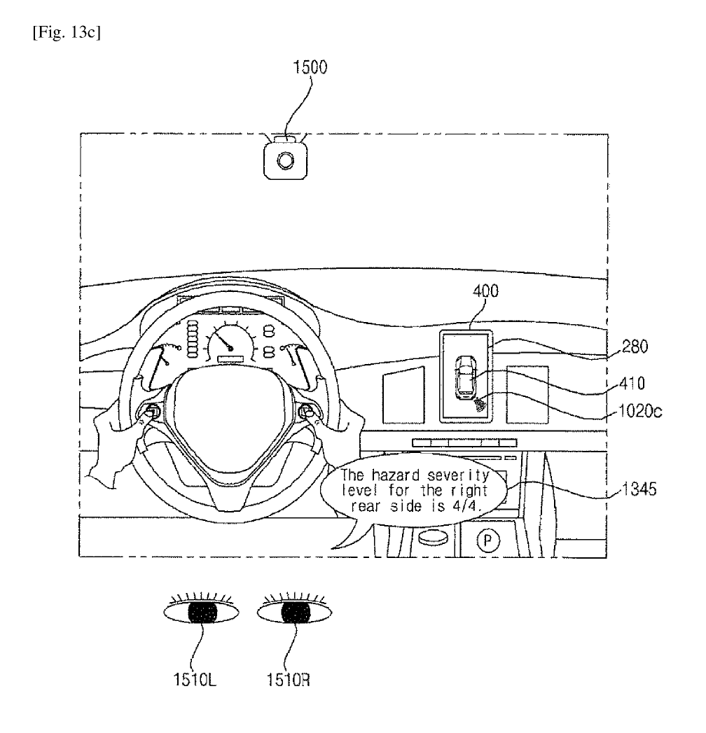

Meanwhile, the autonomous driving apparatus 100, specifically, the around view providing apparatus 100b may further include an internal camera. The processor 270 may recognize the direction of gaze of the driver of the vehicle through an image from the internal camera. If the gaze of the driver is directed to a place around the display on which an around view image containing a level of hazard severity information for an object around the vehicle is displayed, when the hazard severity level for the object rises, a control operation may be performed such that first sound, which is a warning sound, is output through the audio output unit. A more detailed description thereof will be given with reference to FIGS. 13A to 13C.

FIG. 13A illustrate shift of gaze of the driver according to information displayed on a display 280 provided inside the vehicle when an internal camera 1500 for sensing gaze of the user is installed inside the vehicle.

In FIG. 13A, both the left eye 1510L and right eye 1510R of the user are directed to the right corresponding to the position of the display 280.

Thereby, in the situation of, for example, FIG. 10A, the driver verifies the vehicle image 910 and hazard severity object 1020a displayed on the display 280.

The processor 270 may recognize, based on an image captured by the internal camera 1500, that the driver has verified the hazard severity object 1020a.

FIG. 13B illustrates a case where the vehicle is moved further backward to the parking area 900 as shown in FIG. 10B as the driver takes no action after verifying the hazard severity object 1020a of FIG. 13A.

In this case, the processor 270 may perform a control operation such that warning sound 1340 corresponding to first sound is output through the audio output unit 285. Thereby, the driver may recognize the hazard severity more intuitively than in the case of FIG. 13A.

Meanwhile, the hazard severity object 1020b as shown in FIG. 10B may be displayed on the display 180.

FIG. 13C illustrates another case where the vehicle is moved further backward to the parking area 900 as shown in FIG. 10C as the driver takes no action after verifying the hazard severity object 1020a of FIG. 13A.

In this case, the processor 270 may perform a control operation such that warning sound 1345 corresponding to second sound is output through the audio output unit 285. Thereby, the driver may recognize the hazard severity more intuitively than in the case of FIG. 13B. Preferably, the volume of the warning sound 1345 corresponding to the second sound is higher than that of the warning sound 1340 corresponding to the first sound.

Meanwhile, the hazard severity object 1020b as shown in FIG. 10B may be displayed on the display 180.

If the driver of the vehicle does not perform any separate operation even when the hazard severity is at the maximum level as shown in FIGS. 9C, 10C, 11C, 12C and 13C, the processor 270 or ECU 770 of the vehicle 200 may perform a control operation such that the driver assistance operation is performed to avoid a hazard.

For example, as shown in FIGS. 9C, 10C, 11C, 12C and 13C, if the level of calculated hazard severity information is higher than or equal to a first allowable threshold, the processor 270 or ECU 770 of the vehicle 200 may control at least one of the steering drive unit 752 and the brake drive unit 753 or control the power source drive unit 754 to stop operation of the power source.

Specifically, the processor 270 or ECU 770 of the vehicle 200 may control the steering drive unit 752 to move the vehicle to the front left side or rear left side to cope with the hazard on the right rear side of the vehicle as shown in FIGS. 9C, 10C, 11C, 12C and 13C. Alternatively, the processor 270 or ECU 770 of the vehicle 200 may operate the brake drive unit 753 to stop the vehicle or control the power source drive unit 754 to stop operation of the power source. Thereby, the vehicle may be protected from the hazard around the vehicle.

When the vehicle travels without the driver present therein, the processor 270 or ECU 770 of the autonomous driving apparatus 100, specifically, the around view providing apparatus 100b may control levels of hazard severity information to be transmitted to the mobile terminal of a pre-registered user.

That is, when the vehicle travels autonomously, the processor 270 or ECU 770 of the autonomous driving apparatus 100, specifically, the around view providing apparatus 100b may control levels of hazard severity information to the mobile terminal of a preregistered user.

Meanwhile, the processor 270 or ECU 770 of the autonomous driving apparatus 100, specifically, the around view providing apparatus 100b may perform a control operation such that sound corresponding to the hazard severity information is output from the vehicle through the audio output unit.

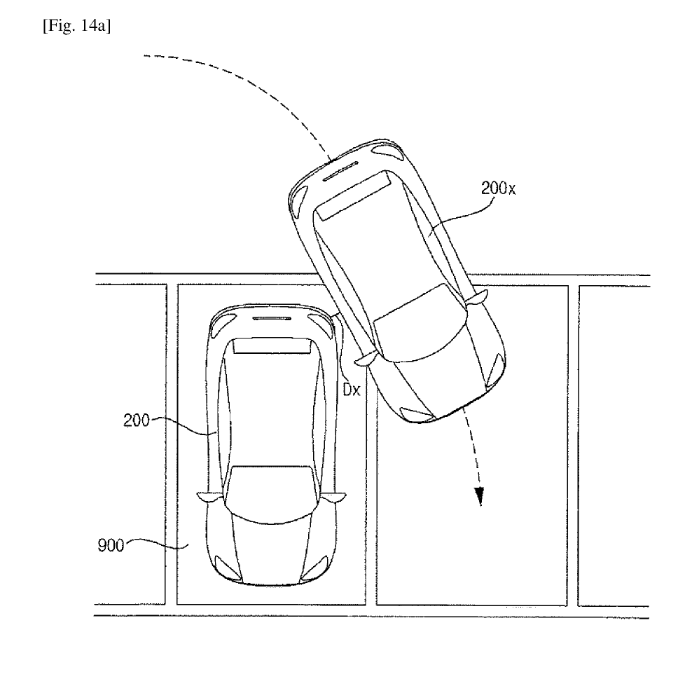

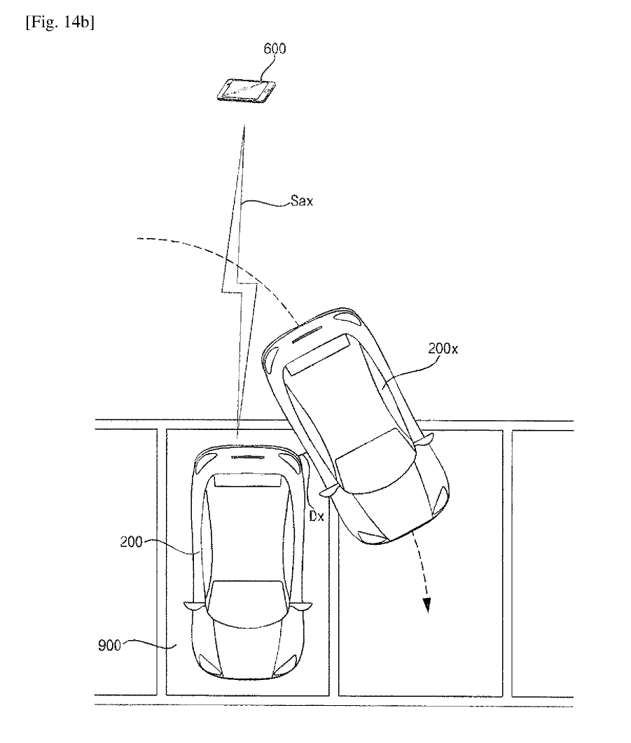

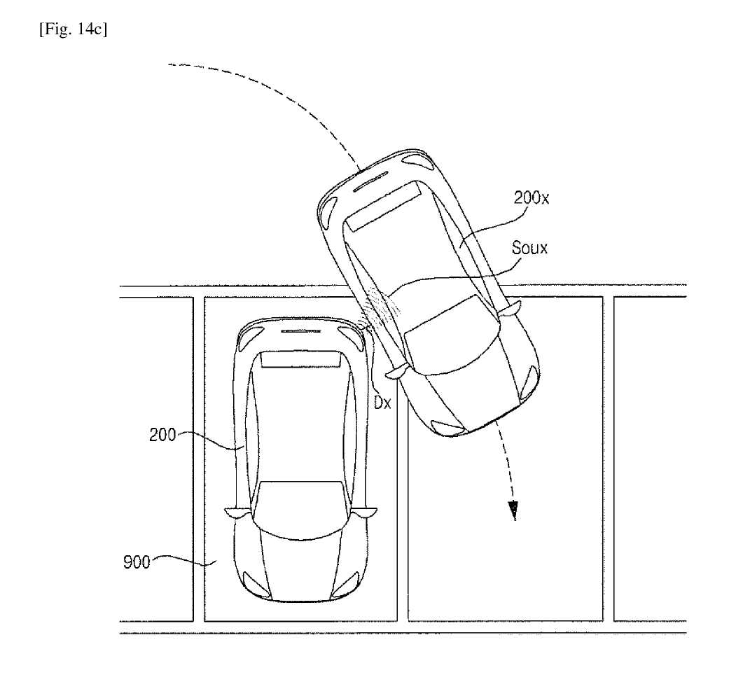

FIG. 14A illustrates a case where a vehicle 200x approaches the parking area 900 with the vehicle 200 parked in the parking area 900.

According to an embodiment of the present measure, while the vehicle remains parked, the processor 270 or ECU 770 of the vehicle 200 may verify objects around the vehicle based on a plurality of images acquired from a plurality of cameras, calculate hazard severity of an object based on at least one of the movement speed, direction, distance and size of the object, and output a level of hazard severity information corresponding to the calculated hazard severity.

In this case, if the distance between the vehicle 200 and another vehicle 200x is excessively decreased to DX as shown in FIG. 14A, namely, if the hazard severity level is higher than or equal to a first predetermined threshold, the processor 270 or ECU 770 of the vehicle 200 may control hazard severity information Sax corresponding to the calculated hazard severity to be transmitted to the mobile terminal 600 of a preregistered user, as shown in FIG. 14B. Thereby, the pre-registered user may quickly recognize a dangerous situation of the parked vehicle.

Meanwhile, if the distance between the vehicle 200 and another vehicle 200x is excessively decreased to DX as shown in FIG. 14A, namely, if the hazard severity level is higher than or equal to a first predetermined threshold, the processor 270 or ECU 770 of the vehicle 200 may perform a control operation such that sound Soux corresponding to the hazard severity information is output from the vehicle to the outside. Thereby, the driver of the other vehicle or a pedestrian may immediately sense the danger of contact with the vehicle. The recording medium readable by the processor includes all kinds of recording devices in which data readable by the processor can be stored. Examples of the recording medium readable by the processor include ROM, RAM, CD-ROM, magnetic tape, floppy disk, and optical data storage. The method is also implementable in the form of a carrier wave such as transmission over the Internet. In addition, the recording medium readable by the processor may be distributed to computer systems connected over a network, and code which can be read by the processor in a distributed manner may be stored in the recording medium and executed.

### MODE FOR THE INVENTION

Various embodiments have been described in the best mode for carrying out the invention.

### INDUSTRIAL APPLICABILITY

According to an embodiment of the present invention, an autonomous driving apparatus and a vehicle including the same include a plurality of cameras and a processor that verifies an object around the vehicle based on a plurality of images acquired from the plurality of cameras, calculates hazard severity of the object based on at least one of the movement speed, direction, distance and size of the object, and outputs a level of hazard severity information corresponding to the calculated hazard severity when the speed of the vehicle is lower than or equal to a first speed or the vehicle is reversed. Thereby, hazard information may be provided based on verification of objects around the vehicle. Accordingly, user convenience may be enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An autonomous driving apparatus comprising:
a plurality of cameras; and
a processor to verify an object around a vehicle based on a plurality of images acquired from the plurality of cameras, calculate hazard severity of the object based on at least one of a movement speed, direction, distance and size of the object, and output a level of hazard severity information corresponding to the calculated hazard severity when the speed of the vehicle is lower than or equal to a first speed or the vehicle is reversed.

2. The autonomous driving apparatus according to claim 1, further comprising:
an interface unit to receive sense information about a movement speed and movement direction of the vehicle,
wherein the processor calculates the hazard severity of the object in further consideration of a movement speed and movement direction of the vehicle, and outputs the level of the hazard severity information corresponding to the calculated hazard severity.

3. The autonomous driving apparatus according to claim 1, wherein the processor sets the level of the hazard severity information in proportion to at least one of the movement speed and size of the object.

4. The autonomous driving apparatus according to claim 1, wherein the processor sets the level of the hazard severity information in inverse proportion to the distance to the object.

5. The autonomous driving apparatus according to claim 1, comprising:
a thermal camera,
wherein the processor sets the level of the hazard severity information in proportion to a detected temperature.

6. The autonomous driving apparatus according to claim 1, wherein the processor calculates a time to collision with an object positioned on a front or side of the vehicle based on images from a front camera and side cameras of the vehicle among the plurality of cameras, calculates the hazard severity based on the time to collision, and outputs the level of the hazard severity information corresponding to the calculated hazard severity.

7. The autonomous driving apparatus according to claim 1, wherein the processor calculates a time to collision with an object positioned on a back or side of the vehicle based on images from a rear camera and side cameras of the vehicle among the plurality of cameras, calculates the hazard severity based on the time to collision, and outputs the level of the hazard severity information corresponding to the calculated hazard severity.

8. The autonomous driving apparatus according to claim 1, further comprising: a display,
wherein, when the speed of the vehicle is lower than or equal to the first speed or the vehicle is reversed, the processor controls the display to display an image indicating the vehicle and the level of the hazard severity information corresponding to the object around the vehicle.

9. The autonomous driving apparatus according to claim 8, wherein the processor generates an around view image based on the images from the plurality of cameras, and performs a control operation such that a movement path of the object around the vehicle is marked in the around view image.

10. The autonomous driving apparatus according to claim 9, wherein the processor performs a control operation such that a movement path of the vehicle is marked in the around view image.

11. The autonomous driving apparatus according to claim 8, further comprising:
an audio output; and
an internal camera,
wherein the processor recognize a direction of gaze of a driver of the vehicle through an image from the internal camera,
wherein, when the level of the hazard severity of the object around the vehicle rises with the gaze of the driver directed to a place around the display having the around view image displayed, the processor performs a control operation such that a first sound corresponding to a warning sound is output through the audio output unit.

12. The autonomous driving apparatus according to claim 8, wherein the processor changes at least one of a color and size of a hazard severity object indicating the hazard severity information according to the hazard severity.

13. The autonomous driving apparatus according to claim 1, further comprising:
an audio input unit to acquire a voice of a driver of the vehicle,
wherein, when sound for displaying the hazard severity information is input from the driver while the speed of the vehicle is lower than or equal to the first speed or the vehicle is reversed, the processor performs a control operation to output the level of the hazard severity information corresponding to the calculated hazard severity.

14. The autonomous driving apparatus according to claim 1, wherein the processor comprises:
a disparity calculator to calculate a disparity for at least one of the images acquired from the plurality of cameras;
an object detector to detect the object around the vehicle based on information indicating the disparity; and
an object tracking unit to track the detected object.

15. The autonomous driving apparatus according to claim 14, wherein the processor further comprises:
a segmentation unit to segment the object based on the information indicating the disparity; and
an object verification unit to classify the detected object,
wherein the object detector detects the object around the vehicle based on the segmented object.

16. The autonomous driving apparatus according to claim 14, wherein, when the vehicle travels without a driver present therein, the processor performs a control operation to transmit the level of the hazard severity information to a mobile terminal of a pre-registered user.

17. A vehicle comprising:
a steering drive unit to drive a steering apparatus;
a brake drive unit to drive a brake apparatus;
a power source drive unit to drive a power source;
a plurality of cameras; and
a processor to verify an object around a vehicle based on a plurality of images acquired from the plurality of cameras, calculate hazard severity of the object based on at least one of a movement speed, direction, distance and size of the object, and output a level of hazard severity information corresponding to the calculated hazard severity when the speed of the vehicle is lower than or equal to a first speed or the vehicle is reversed.

18. The vehicle according to claim 17, wherein, when the level of the calculated hazard severity information is higher than or equal to a first allowable threshold, the processor controls at least one of the steering drive unit and brake drive unit or controls the power source drive unit to stop operation of the power source.

19. The vehicle according to claim 17, further comprising:
a sensor unit to sense a movement speed and movement direction of the vehicle,
wherein the processor calculates the hazard severity of the object in further consideration of a movement speed and movement direction of the vehicle, and outputs the level of the hazard severity information corresponding to the calculated hazard severity.

20. The vehicle according to claim 17, further comprising:
a display,
wherein, when the speed of the vehicle is lower than or equal to the first speed or the vehicle is reversed, the processor controls the display to display an image indicating the vehicle and the level of the hazard severity information corresponding to the object around the vehicle.

21. The vehicle according to claim 17, further comprising:
an audio output capable of outputting sound from the vehicle,
wherein the processor performs a control operation such that sound corresponding to the hazard severity information is output through the audio output unit.

22. The vehicle according to claim 17, wherein, when the vehicle travels without a driver present therein, the processor performs a control operation to transmit the level of the hazard severity information to a mobile terminal of a pre-registered user.
